(19) United States
(12) Patent Application Publication
(10) Pub. No.: US 2007/0112782 A1
(43) Pub. Date: May 17, 2007

(54) Clinical decision support system

(76) Inventors: David F. Lobach, Durham, NC (US); Kensaku Kawamoto, Durham, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/515,556

(22) Filed: Sep. 5, 2006

Related U.S. Application Data
(60) Provisional application No. 60/714,429, filed on Sep. 6, 2005.

(51) Int. Cl. G06N 5/04; G06F 17/30

(52) U.S. Cl. 707/10; 706/60

(57) ABSTRACT

A clinical decision support system enabling sharing of medical knowledge in a machine executable format, implementable as a network-based system in which individual executable knowledge modules (EKMs) define the data requirements for assessing a patient, the conclusions that can be drawn using that data, and instructions on how to generate those conclusions. Using standards-based messages transmitted over a network, client decision support applications provide patient data to the system and receive patient-specific assessments and recommendations. The system permits re-use of executable medical knowledge across diverse applications and care settings, easy authoring of knowledge modules, and use of the system framework to implement decision support applications having significant clinical utility.

### GOVERNMENT RIGHTS IN INVENTION

Work related to the present invention was conducted in the performance of the following U. S. Government contracts: National Institutes of Health grants T32-GM07171 and F37-LM008161; Agency for Healthcare Research and Quality (AHRQ) grants R0-HS10472, R01-HS-015057, and R03-HS10814; and Health Resources and Services Administration grant H2ATH00998. The Government may have certain rights in the invention.

### FIELD OF THE INVENTION

The present invention relates to a network-based clinical decision support system useful in the delivery of healthcare services, which provides medical advice to client systems, and to a methodology for encoding, processing and delivering machine-executable medical decision logic.

### DESCRIPTION OF THE RELATED ART

As the volume of information published in the biomedical literature continues to increase at an exponential rate, dissemination of this medical knowledge through traditional channels (e.g., by publication of evidence-based guidelines and in continuing medical education programs) is increasingly inadequate.

In consequence, healthcare services delivery and quality are adversely impacted. In the United States alone, a recent nationwide audit assessing 439 quality indicators found that American adults receive only about half of recommended care (McGlynn, E. A., Asch, S. M., Adams, J., et al., The quality of health care delivered to adults in the United States, N. Engl. J. Med. 2003, 348:2635-2645), and the United States Institute of Medicine has estimated that up to 98,000 Americans die each year as the result of preventable medical errors (Kohn, L. T., Corrigan, J. M., Donaldson, M. S., eds., To Err is Human: Building a Safer Health System. Washington, D.C., National Academy Press, 1999). Similar deficiencies in healthcare services delivery and quality also have been found in other industrialized nations.

One of the most promising strategies for addressing this crisis in healthcare quality is the use of computer systems to support clinical decision making, e.g., by delivering patient-specific assessments and recommendations to clinicians (Kawamoto, K., Houlihan, C. A., Balas, E. A., Lobach, D. F., Improving clinical practice using clinical decision support systems: a systematic review of trials to identify features critical to success, BMJ, 2005, 330:765-772). The availability of such decision support capabilities, however, remains limited in most healthcare facilities in the United States and other countries.

While multiple factors have contributed to this limited use of decision support systems, one important factor has been the difficulty of re-using medical knowledge encoded in a machine-executable format (see Boxwala, A. A., Tu, S., Peleg, M., et al., Toward a representation format for sharable clinical guidelines, J. Biomed. Inform., 2001,34:157-169).

In attempting to overcome this problem, knowledge engineers have generally taken two approaches (Boxwala, A. A., Tu, S., Peleg, M., et al., Toward a representation format for sharable clinical guidelines, J. Biomed. Inform., 2001, 34:157-169).

As one approach, systems such as PRODIGY (Johnson, P. D., Tu, S., Booth, N., Sugden, B., Purves, I. N., Using scenarios in chronic disease management guidelines for primary care, Proc. AMIA Symp., 2000, 389-393), SAGE (Tu, S. W., Musen, M. A., Shankar, R., et al., Modeling guidelines for integration into clinical workflow, Medinfo., 2004, 2004:174-8), and First DataBank's Drug Information Framework™ (First DataBank. Drug Information Framework Information Page, at: http://www.firstdatabank.com/integrated _content/drug_information, accessed Mar. 3, 2005) provide access to their executable knowledge base using standard application programming interfaces.

As a second approach, methods including GLIF3 (Peleg, M., Boxwala, A. A., Ogunyemi, O., et al., GLIF3: the evolution of a guideline representation format, Proc AMIA Symp., 2000, 645-649), GEM (Shiffman, R. N., Michel, G., Essaihi, A., Thornquist, E., Bridging the guideline implementation gap: a systematic, document-centered approach to guideline implementation, J. Am. Med. Inform. Assoc., 2004, 11:418-426), and the Arden Syntax (Pryor, T. A., Hripcsak, G., The Arden syntax for medical logic modules, Int. J. Clin. Monit. Comput., 1993, 10:215-224) encode knowledge using a common formalism, so that encoded rules can be consistently interpreted by system-specific interpreters.

Despite these significant efforts, a dominant framework has not emerged for sharing executable medical knowledge, due in part to the following challenges. First, some formalisms, such as the aforementioned Drug Information Framework™, focus on specific knowledge domains and are not extendable to other domains. Second, many formalisms are designed for use in specific types of decision support applications and are difficult to adapt for use in other types of applications. Third, many formalisms are difficult to understand due to their conceptual complexity. Fourth, many existing architectures require the client to provide the decision support engine with relatively unfettered read or write access to its clinical database. Fifth, most architectures do not support the use of multiple underlying knowledge representation approaches, despite the fact that a knowledge representation approach appropriate for modeling one type of medical knowledge may not be appropriate for modeling other types of medical knowledge. For example, a Task-Network Model (Peleg, M., et al. Comparing computer-interpretable guideline models: a case-study approach, J. Am. Med. Inform. Assoc., 2003, 10:52-68) may be appropriate for modeling a complex clinical guideline, but knowledge on medication contraindications may be more efficiently represented using a domain-specific relational database format. Finally, many existing methods require significant investments in infrastructure, such as a system-specific compiler (Karadimas, H. C., Chailloleau, C., Hemery, F., Simonnet, J., Lepage, E., Arden, J., An architecture for MLM execution on the Java platform, J. Am. Med. Inform. Assoc., 2002, 9:359-368) or a virtual medical record (vMR) implementation (Tu, S. W., Musen, M. A., Shankar, R., et al., Modeling guidelines for integration into clinical workflow, Medinfo., 2004, 2004:174-8).

It would therefore be a significant advance in the art to provide a clinical decision support system in which medical decision logic can be embedded in clinical software applications in an efficient and generalizable manner. Such achievement would allow for the more widespread adoption of clinical decision support systems, which have been demonstrated to be one of the most promising interventions available for improving the efficiency and effectiveness of health care.

### SUMMARY OF THE INVENTION

The present invention relates to a clinical decision support system and method for encoding, processing and delivering machine-executable medical decision logic.

In one aspect, the invention relates to a clinical decision support system, comprising a network server adapted for communication with a network by which the network server and a client can communicate with one another, wherein said client includes one or more client applications and one or more patient data sources,

said network server being programmably coupled with one or more modules of knowledge capable of using patient data to make inferences regarding a patient,

wherein said network server is capable of communicating to said client what knowledge modules are available for evaluating patients,

wherein said network server is capable of communicating to said client the data requirements for evaluating a patient using one or more said knowledge modules,

wherein said network server is capable of communicating to said client what conclusions can be drawn regarding a patient using one or more said knowledge modules,

wherein said network server is programmably arranged for said communication with said client to (i) receive from said client application requests to evaluate one or more patients using one or more said knowledge modules, wherein the data provided by the client application includes patient data obtained from said patient data source(s), and to (ii) responsively transmit to said client application patient-specific inferences, and

wherein communications between said network server and said client application utilize a network communications language that is interoperative with different operating systems and programming languages.

In another aspect, the invention relates to a clinical decision network system, comprising a clinical decision support system as described, a client including one or more client applications and one or more patient data sources, and a network interconnecting the network server and client for communication with one another.

In a further aspect, the invention relates to a method for implementing the clinical decision support system as described, involving the programmatic coupling of the aforementioned network server with a plurality of executable knowledge modules that specify the data requirements for assessing a patient, the patient-specific conclusions that can be drawn from using that data, and the instructional logic utilized to generate the patient-specific conclusions using the specified data.

In a further aspect, the invention relates to a method for (i) converting the data requirements specified in the aforementioned executable knowledge modules into programmatic objects that contain data matching the specified requirements, and for (ii) allowing the manipulation of said programming objects in a native programming environment in order to generate the patient-specific results returned by the network server.

In a further aspect, the invention relates to a method of providing clinical decision support in a medical care facility, comprising use of a clinical decision support system as described, for network support of a clinical client associated with said medical care facility.

A further aspect of the invention relates to a method of health care services delivery, comprising providing a Web service for clinical decision support, in which said Web service comprises use of a clinical decision support system as described.

A still further aspect of the invention relates to a framework for implementing clinical decision support systems, comprising a plurality of executable knowledge modules (EKMs) that define the data requirements for assessing a patient, the conclusions that can be drawn using that data, and instructions on how to generate those conclusions, said framework being adapted for implementation of a Web service providing clinical decision support to a clinical client in communication with said framework.

Other aspects, features and embodiments of the invention will be more fully apparent from the ensuing disclosure and appended claims.

### BRIEF DESCRIPTION OF THE DRAWINGS

FIG. 1 is a schematic representation of a clinical decision support system including executable knowledge modules (EKMs), according to one embodiment of the invention. An EKM is alternatively referred to as a Patient Safety Module (PSM) in the ensuing text.

FIG. 2 is a schematic representation of one embodiment of a PSM, comprising a maintenance, library, knowledge, and logic section, in an illustrative embodiment.

FIG. 3 is a schematic representation of the maintenance section of an EKM, in an illustrative embodiment.

FIG. 4 is a screen of the maintenance section of an EKM, as viewed through a Microsoft InfoPath® editing environment, in an illustrative embodiment.

FIG. 5 is a schematic representation of the library section of an EKM, in an illustrative embodiment.

FIG. 6 is a screen of the library section of an EKM, as viewed through an InfoPath® editing environment, in an illustrative embodiment.

FIG. 7 is a schematic representation of the data requirement subsection of the knowledge section of an EKM, in an illustrative embodiment.

FIG. 8 is a screen of the data requirement subsection of the knowledge section of an EKM, as viewed through an InfoPath® editing environment, in an illustrative embodiment.

FIG. 9 is a screen of the data requirement subsection of the knowledge section of an EKM, as viewed through an InfoPath® editing environment, in an illustrative embodiment.

FIG. 10 is a schematic representation of the results returned subsection of the knowledge section of an EKM, in an illustrative embodiment.

FIG. 11 is a screen of the results returned subsection of the knowledge section of an EKM, as viewed through an InfoPath® editing environment, in an illustrative embodiment.

FIG. 12 is a screen of the logic section of an EKM, as viewed through an InfoPath® editing environment, in an illustrative embodiment.

FIG. 13 is a screen of the logic section of an EKM, as viewed through a Java Integrated Development Environment (IDE), in an illustrative embodiment.

FIG. 14 is a schematic representation of a client's request for a patient to be evaluated using designated executable knowledge modules, in an illustrative embodiment.

FIG. 15 is a sample XML communication representing a client's request for a patient to be evaluated using designated executable knowledge modules, in an illustrative embodiment.

FIG. 16 is a schematic representation of the response to a client's request for a patient to be evaluated using designated executable knowledge modules, in an illustrative embodiment.

FIG. 17 is a schematic representation of a client's request to search for EKMs meeting search criteria, in an illustrative embodiment.

FIG. 18 is a schematic representation of the response to a client's request to search for EKMs meeting search criteria, in an illustrative embodiment.

FIG. 19 is a schematic representation of a client's request to obtain information regarding a specified EKM, in an illustrative embodiment.

FIG. 20 is a schematic representation of the response to a client's request to obtain information regarding a specified EKM, in an illustrative embodiment.

FIG. 21 is a schematic representation of a client's request for a specification of the data required to evaluate a patient using the designated executable knowledge modules, in an illustrative embodiment.

FIG. 22 is a schematic representation of the response to a client's request for a specification of the data required to evaluate a patient using the designated executable knowledge modules, in an illustrative embodiment.

FIG. 23 is a screen of a sample clinic feedback report generated using the present invention, in an illustrative embodiment.

FIG. 24 is a screen of a sample provider alert generated using the present invention, in an illustrative embodiment.

FIG. 25 is a screen of a statistical feedback report generated using the present invention, in an illustrative embodiment.

FIG. 26 is a screen of a sample patient letter generated using the present invention, in an illustrative embodiment.

FIG. 27 is a clinical decision support system according to another embodiment of the invention constituting a diabetes reminder system (DRS), including EKMs and a health system's common data repository (CDR).

FIG. 28 is a screen of a diabetes care reminder sheet generated using the present invention, in an illustrative embodiment.

### DETAILED DESCRIPTION OF THE INVENTION, AND PREFERRED EMBODIMENTS THEREOF

For ease of description in the ensuing discussion, the following terms will have the following meanings:

“Clinical decision support” means the provision of patient-specific inferences to an entity interested in or involved in the health care of said patient;

“RIM” means the Health Level 7 (HL7) Reference Information Model;

“Web” means World Wide Web;

“World Wide Web” means a network of servers that supports the exchange of documents to and from computers connected to that network;

“HTML” means Hypertext Markup Language;

“HTTP” means Hypertext Transfer Protocol;

“Web service” means software that makes itself available over a network and uses a standardized or accepted messaging communication language, such as XML on the Internet (see also http://webservices.xml.com/pub/a/ws/2002/02/12/webservicefaqs.html, accessed Mar. 3, 2005);

“XML” means Extensible Markup Language, a communications language that is interoperative with different operating systems and programming languages; and

“framework” means a partially complete, or semi-finished software support structure that is intended to be instantiated, which defines the architecture for a family of software applications and provides the basic building blocks to create them, typically including support programs, code libraries and a scripting language, and constituting a set of software routines that provide a foundation structure for an application, as a semi-complete application that can be customized to produce custom applications (in object-oriented environments, a framework can be constituted by abstract and concrete classes, as a class library that is instantiated by composing and subclassing the existing classes; commercially available frameworks include source applications such as MacApp, ET, Interviews, ACE, Microsoft MFC and DCOM, JavaSoft RMI, and OMG CORBA, as well as other frameworks targeted to specific businesses and application domains).

The present invention relates to a clinical decision support system and method for efficiently encoding, processing, and delivering machine-executable medical decision logic for use in medical software applications.

The design of the clinical decision support system and methodology of the invention is based on the objectives of (1) providing “write once, run anywhere” portability for executable medical knowledge, (2) allowing both simple and complex knowledge modules to be authored in a straightforward fashion, and (3) minimizing the effort required to understand and use the system.

The system and methodology of the invention are described hereinafter with reference to an exemplary implementation that is sometimes hereinafter denoted as SEBASTIAN, an acronym for System for Evidence-Based Advice through Simultaneous Transaction with an Intelligent Agent across a Network. It will be appreciated that such SEBASTIAN system is illustrative of certain features, aspects and embodiments of the invention, and that the ensuing description is not intended to be limitingly construed as regards the scope of the present invention, inasmuch as the system and method of the invention may be practiced in a wide variety of arrangements and forms, as will be apparent to skilled persons in the art, based on the disclosure herein.

The system of the present invention is a clinical decision support system that interacts synchronously with client software applications to deliver decision support over a network, e.g., an intranet, extranet and/or internet. Preferably, the network includes servers supporting information protocols, such as HTTP, affording communication via the World Wide Web. A network intermediary may not be required in the special case that the decision support system is located on the same computer as the client software application.

In the illustrative embodiment of the invention constituting the SEBASTIAN system, the clinical decision support system of the invention is implemented as a Web service system, in which software functionality is provided over the Internet and extensible markup language (XML) messages are used to communicate with client systems. The system includes a framework that can, for example, be implemented as a Java servlet and be hosted by a corresponding servlet container, e.g., an Apache Tomcat servlet container.

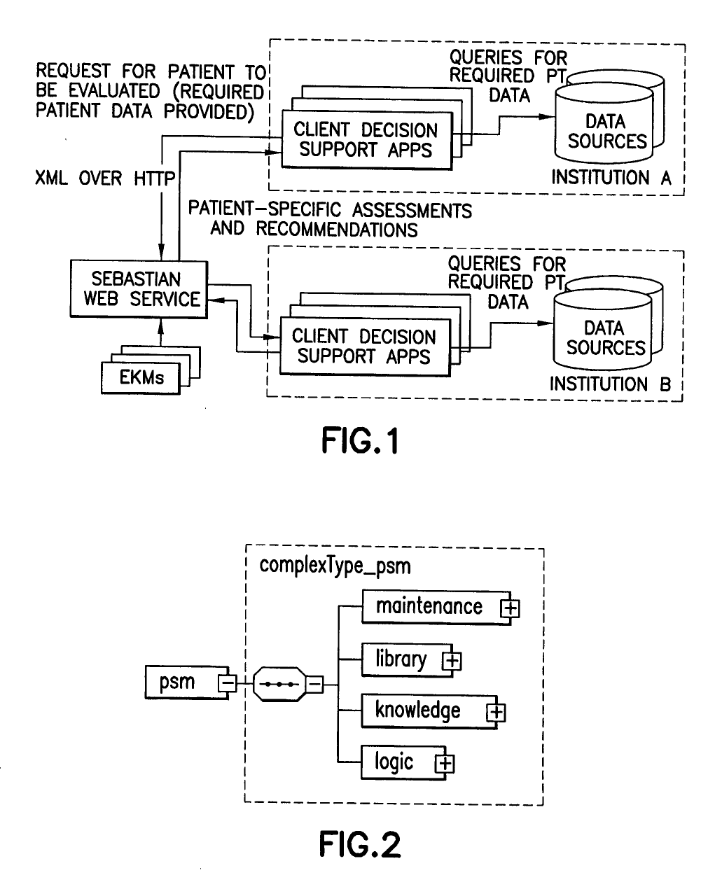

An overview of the illustrative SEBASTIAN architecture is provided in FIG. 1, which is a schematic representation of a clinical decision support system including executable knowledge modules (EKMs), according to one embodiment of the invention. The salient features of this architecture are briefly described below, and then subsequently described in greater detail.

Patient Information Model—Overview. The SEBASTIAN system can employ any suitable patient information model, e.g., a patient information model based on the Health Level 7 (HL7) Reference Information Model (RIM) (see Health Level 7. HL7 Data Model Development, available at: http://www.hl7.org/library/data-model/, accessed Mar. 3, 2005), and concepts can be identified using standard vocabularies, e.g., vocabularies included in the National Library of Medicine's Unified Medical Language System (UMLS) (see National Library of Medicine Unified Medical Language System, available at: http://www.nlm.nih.gov/research/umls/, accessed Mar. 3, 2005).

Executable Knowledge Modules—Overview. Medical knowledge in the clinical decision support system is captured in XML documents known as Executable Knowledge Modules (EKMs), which are also sometimes herein referred to as Patient Safety Modules (PSMs). In one embodiment of the invention, each module includes a specification of the data requirements for assessing a patient, the patient-specific conclusions that will be returned by the module, and the logic that will be utilized to generate the conclusions using the specified patient data.

Services Provided—Overview. The clinical decision support system utilizes the knowledge encoded in the EKMs to offer any of various services to client decision support applications. A “service” in this context means a software capability made available over a network. Note that alternate terms used to describe this concept in the field may include “service operation,” “service method,” “service function,” “service interface,” or “service capability.” With SEBASTIAN configured as a Web service, services can be accessed by sending XML requests over HTTP or over HTTPS (HTTP over Secure Socket Layer). The system can be configured and operated to provide a patient evaluation service as a core service, in which patient data elements are received as the input and machine-interpretable decision support results are returned as the output.

Use of SEBASTIAN System by Clients—Overview. To receive patient-specific advice from the SEBASTIAN system, client decision support systems first retrieve the required patient data elements from one or more data sources. Then, the client sends the patient information to the SEBASTIAN system, receives structured decision support results from the SEBASTIAN system in return, and uses those results as desired. This ensuing discussion describes each of these aspects of the SEBASTIAN framework in greater detail.

Patient Information Model—Details. In one embodiment, the SEBASTIAN system uses a standards-based patient information model based on the HL7 RIM. Patients are modeled as entities described by demographic and “act” data, where an act refers to any act or service constituting health care services, such as an encounter, diagnosis, or procedure.

A patient's demographic data can for example include gender, race(s), age, and birth date.

In addition, a patient can participate in health care acts, in which each act possesses the attributes listed in Table 1.

TABLE 1
Attributes common to all acts.

| Attribute | Description and Example |
|---|---|
| act type | The type of act (e.g. encounter diagnosis) |
| identifying | Code that identifies the act |
| code | (e.g. “250.01” in ICD9CM version 2005) |
| act start/end | The time when the act started/ended |
| time | (e.g. 2005-03-15T00:00:00) |
| encounter ID | The identifier of the encounter associated |
| (optional) | with the act (e.g. Health System A Encounter ID, 12345) |
| provider ID | The identifier of the provider associated |
| (optional) | with the act (e.g. Health System A Provider ID, 67890) |

The encounter ID associated with an act is sometimes needed to identify which acts occurred as part of the same encounter, and the provider ID associated with an act is sometimes needed to identify which acts were performed by a same provider. The use of UMLS vocabularies is preferred when identifying an act. Act subclasses may contain class-specific attributes, such as a value for an observation or a goal.

In one embodiment of the invention, the patient model includes the following act types: encounters, encounter diagnoses, problem list entries, procedures, observations, goals, medication orders, program enrollments, provider assignments, invoices, and past EKM evaluation results, wherein EKM results are the primary objects returned to client systems following the evaluation of a patient.

In addition to the basic act attributes, EKM results can possess the attributes illustratively listed in Table 2 below.

TABLE 2
EKM result attributes.

| Attribute | Example |
|---|---|
| result code | 003 |
| result code | Diabetes_last_hgbalc_bet_5_and_6_mo |
| short description | |
| result code | Patient with diabetes, last HgbAlc |
| long description | test 5-6 months ago |
| patient-specific | Patient with diabetes and last HgbAlc |
| assessment | 5 mo and 21 d back (8.5% on Oct. 15, 2004). |
| patient-specific | Recommend HgbAlc test to maintain |
| recommendation | test frequency at q6mo. |
| result parameters | lastTestDate → 2004-10-15; |
| | lastTestValue → 8.5; daysUnitlDue → 9 |

It will be appreciated that the system of the invention may utilize alternative patient information models, including other information models based on the HL7 RIM.

Executable Knowledge Modules—Details. As discussed hereinabove, the SEBASTIAN system can be constructed and operated to encapsulate knowledge in XML-based Executable Knowledge Modules (EKMs), also referred to as Patient Safety Modules (PSMs). The scope of an EKM is the assessment of a single patient in a specified topic area. The topic area may be narrow (e.g., the need for a glycated hemoglobin test for a patient with diabetes) or broad (e.g., the existence of contraindications to any medications prescribed or about to be prescribed for a patient). Once the EKMs are encoded, the decision logic can be processed and delivered by a software service that utilizes a standards-based input/output interface to efficiently integrate machine-executable decision logic into various medical software applications.

EKMs can be constructed to include maintenance, library, knowledge, and logic sections. A schematic representation of an EKM is provided in FIG. 2. Module sections can be edited as appropriate using functionally rich editing environments, such as a form-based editing environment developed using Microsoft InfoPath® technology. Preferred editing environments include those that provide extensive terminology support, for example by enabling an author to translate between vocabularies when specifying a clinical concept using multiple vocabularies.

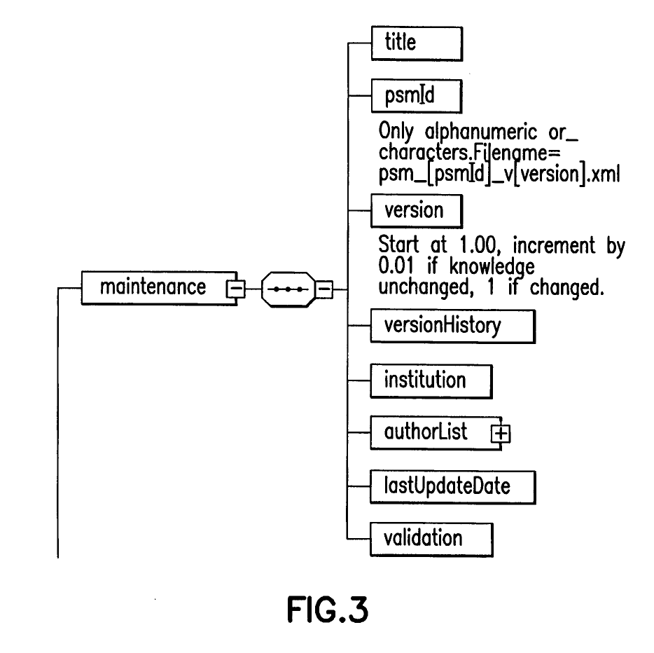

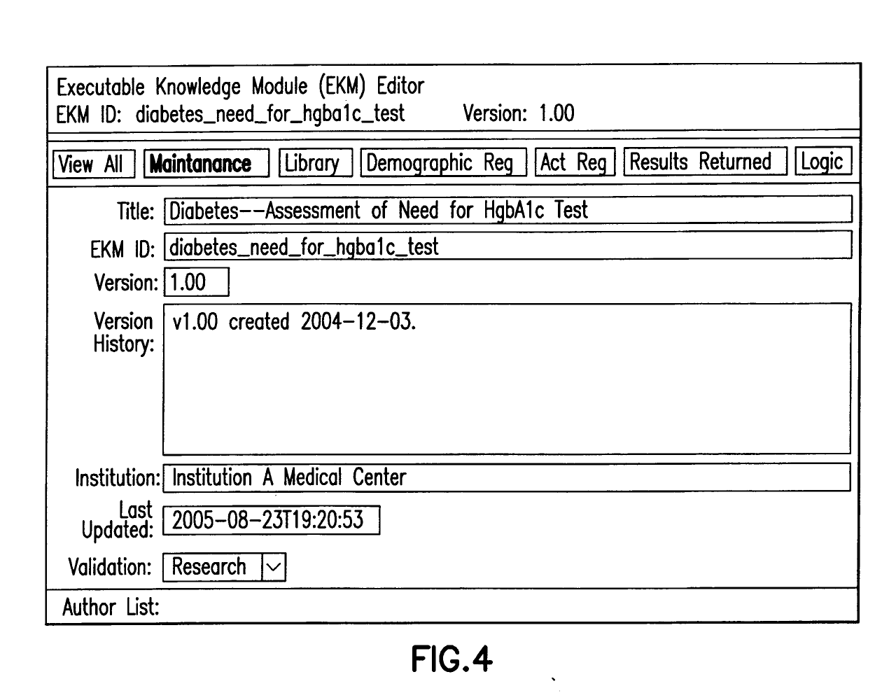

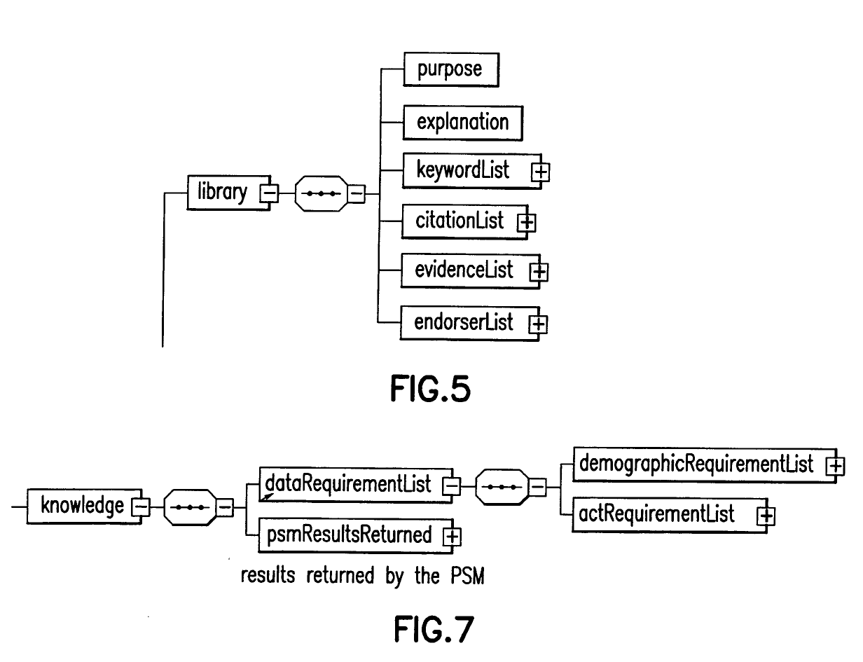

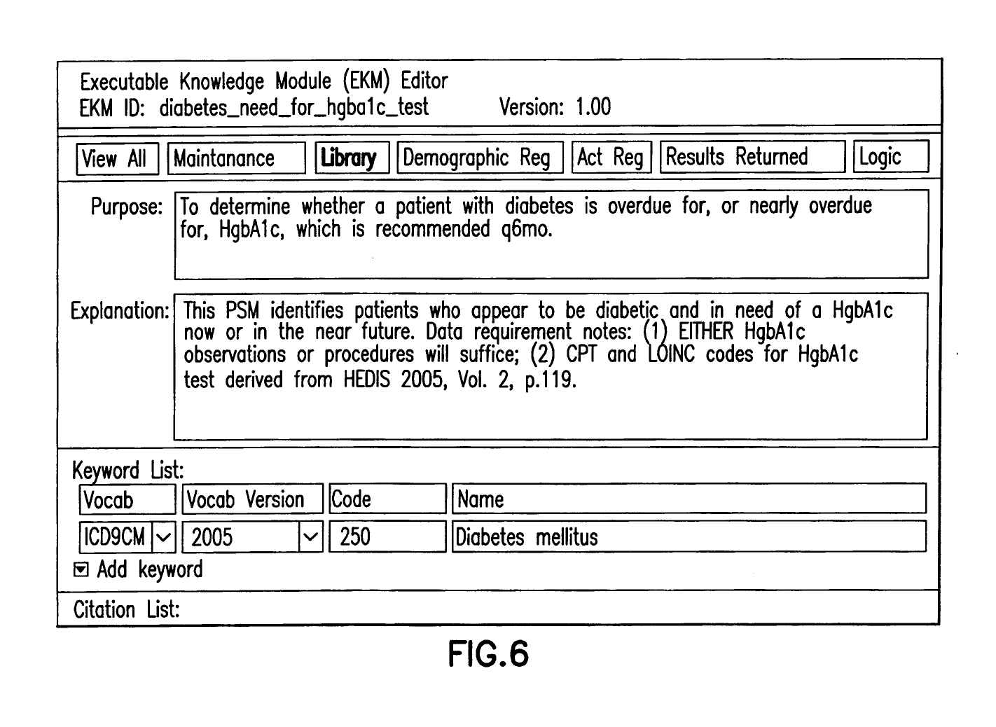

The maintenance and library sections of the SEBASTIAN system can be configured in any suitable manner, e.g., with the maintenance section including general maintenance information, such as the title, identifier, version number, and authors, and with the library section including bibliographic information, such as the purpose of the EKM, how the EKM is implemented, keywords, references, and entities endorsing the module contents. In a specific embodiment, the maintenance and library sections of the SEBASTIAN system can be configured using content categories similar to corresponding sections of the Arden syntax, which is generally described in Pryor, T. A., Hripcsak, G., The Arden syntax for medical logic modules, Int. J. Clin. Monit. Comput., 1993, 10:215-224, the disclosure of which hereby is incorporated herein by reference, in its entirety. FIG. 3 provides a schematic representation of a maintenance section in a specific embodiment, and FIG. 4 provides a screen of the maintenance section as edited in an InfoPath® form. FIG. 5 provides a schematic representation of a library section in a specific embodiment, and FIG. 6 provides a screen of the library section as edited in an InfoPath® form.

The knowledge section of the SEBASTIAN system defines the data requirements for evaluating patients using the module. In one specific embodiment, the data requirements include demographic data requirements and act data requirements. Other types of data, such as client preferences or the context in which the clinical decision support system is being used (e.g. clinic setting versus hospital setting), may also be considered valid data requirements for a knowledge module. In one specific embodiment, demographic requirements are specified by indicating whether gender, race, age, and/or birth date are required, and act requirements are specified by indicating the type of act required, the codes that identify the required act (codes can be specified in multiple vocabularies), how far back to look for that data, whether the associated encounter ID is required, and whether the associated provider ID is required. It will be appreciated that data requirements could be specified using alternative mechanisms, such as the use of the GELLO expression language (Sordo, M., Boxwala, A. A., Ogunyemi, O., Greenes, R. A. Description and status update on GELLO: a proposed standardized object-oriented expression language for clinical decision support. Medinfo, 2004, 11:164-168). Also, it will be appreciated that the knowledge section allows data requirements for a single clinical concept to be represented using multiple vocabularies, including both standard and non-standard vocabularies, and that the editing environment can be arranged to facilitate translation between vocabularies when specifying a concept in multiple vocabularies. Furthermore, it will be appreciated that one module can require the results of another module in the system. In such cases of “nesting,” the system is configured so that the pre-requisite module is evaluated first and its results are made available to the dependent module.

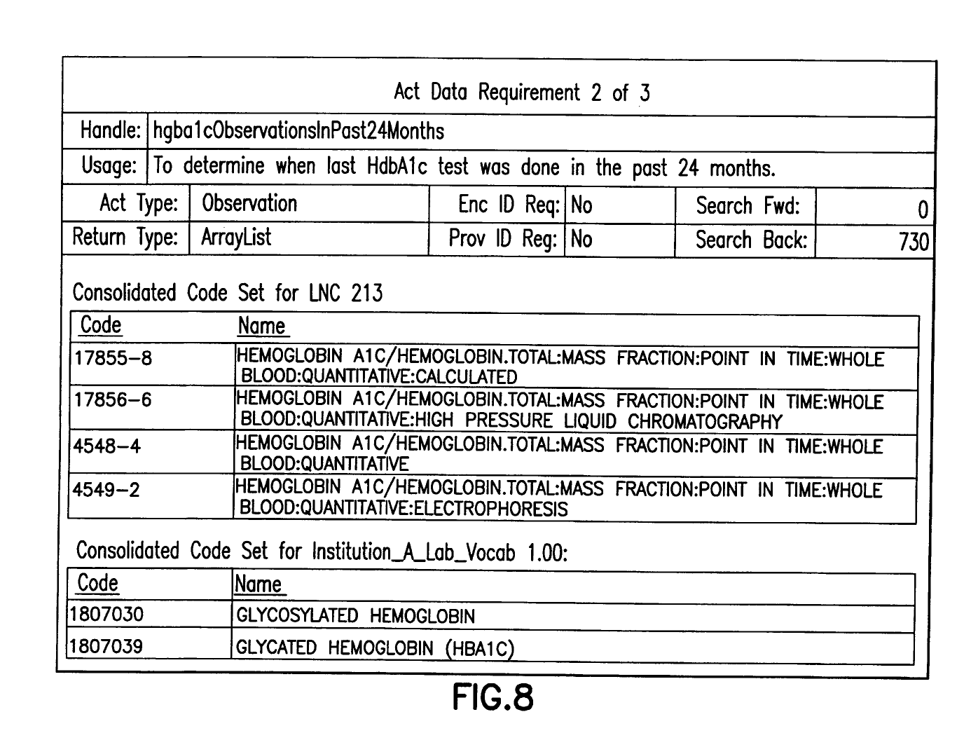

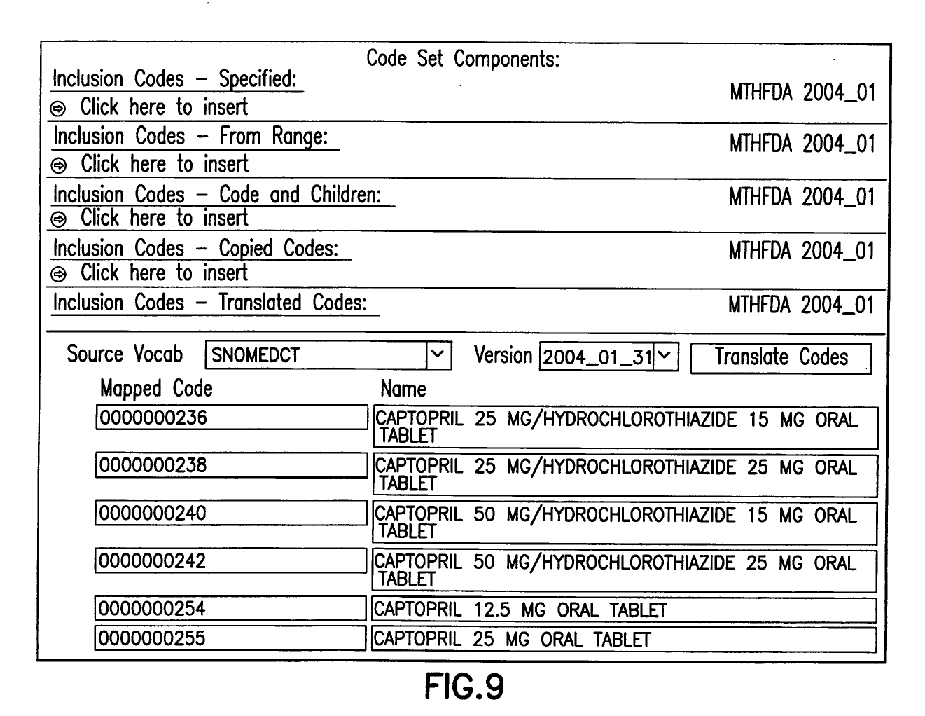

FIG. 7 provides a schematic representation of the data requirement subsection of the knowledge section in a specific embodiment, FIG. 8 provides a screen of the act requirement subsection of the knowledge section as viewed in an InfoPath® form, and FIG. 9 provides a screen of the act requirement subsection as edited in an InfoPath® form. It will be appreciated in FIG. 8 that the same clinical concept (a glycated hemoglobin test) is being represented using multiple vocabularies, one of which is a standard vocabulary (LOINC), whereas the second is a non-standard vocabulary specific to an institution (e.g., an institution's laboratory vocabulary). Also, it will be appreciated in FIG. 9 that the specification of a clinical concept in multiple vocabularies is being supported by a terminology support feature that, in this case, is being used to automatically translate SNOMED CT codes representative of angiotensin converting enzyme inhibitors to unique drug identifiers used by the Food and Drug Administration.

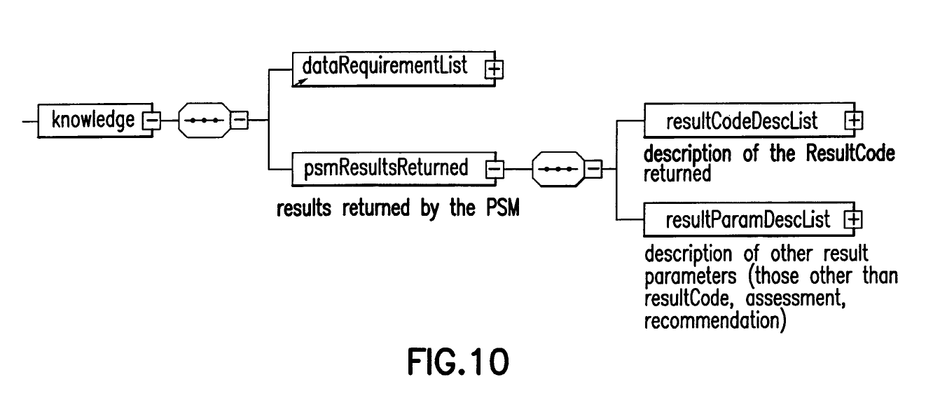

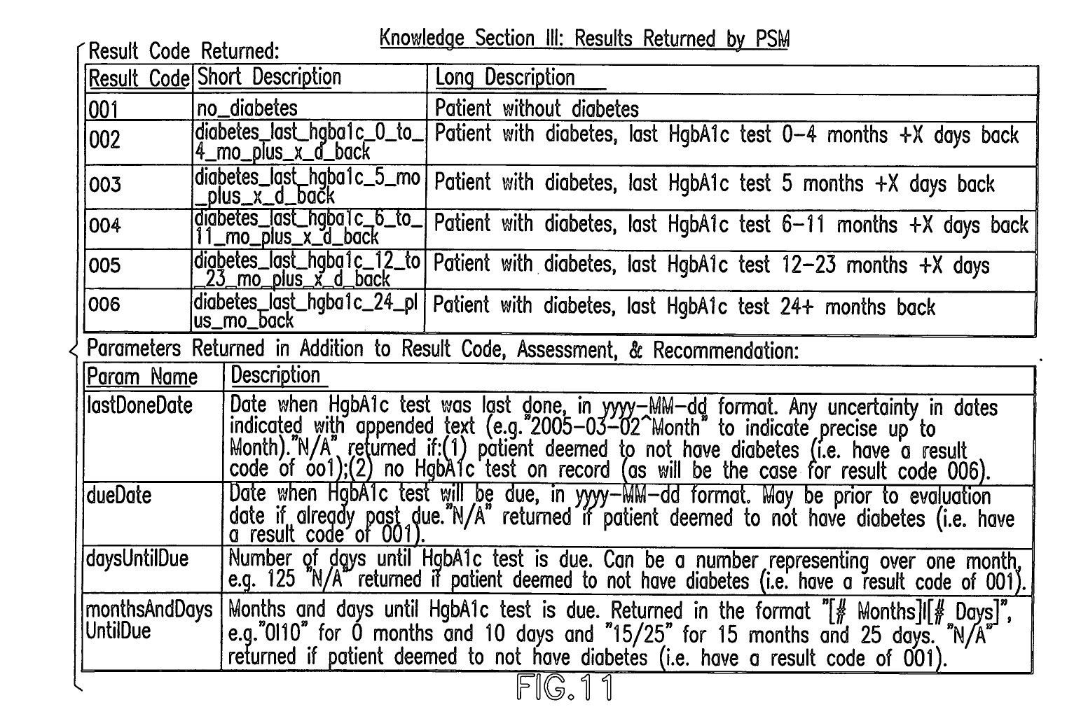

The knowledge section also defines the machine-interpretable results that will be returned to the client. FIG. 10 provides a schematic representation of the knowledge section, which contains explanations of result codes that will be returned, as well as descriptions of machine-interpretable result parameters that will be returned.

Each potential result code is accompanied by a description. Also, the result parameters that will be returned (e.g. lastTestDate, daysUntilDue) are specified and described, e.g., including the result parameters illustratively specified in Table 2. FIG. 11 provides a screen that describes the results that will be returned by an EKM that evaluates whether the patient has diabetes mellitus and requires a glycated hemoglobin test. It will be appreciated that while this specific embodiment represents result parameters as string name-value pairs, the system of the invention could provide clients with other types of result objects, such as HL7 RIM objects represented using XML.

The logic section of the SEBASTIAN system specifies how the patient data provided by the client will be used to derive the EKM results promised in the knowledge section. While the system of the invention could be adapted to specify this instructional logic in multiple ways, the SEBASTIAN system takes the approach of generating a corresponding Java class for each knowledge module in its repository. Within these Java classes, the module author can access the required data elements as native Java objects. For example, if a module requires encounter diagnoses for diabetes from the past 12 months, the SEBASTIAN system will auto-generate an array that will be populated at runtime by Encounter Diagnosis objects that meet the specified selection criteria. Given this mechanism for accessing required data elements, an author can use standard programming methods to generate and return an EKM result object conforming to the output specification described in the knowledge section.

Because the decision logic is expressed in native Java, an author can edit logic rules using powerful and widely available Java programming environments. Moreover, authors have significant latitude in deciding how to produce the required results given the available patient data. For example, authors can create utility classes to handle common operations, query medical knowledge stored in databases, or invoke external decision support engines. As such, SEBASTIAN can be adapted to support the use of multiple underlying knowledge representation approaches.

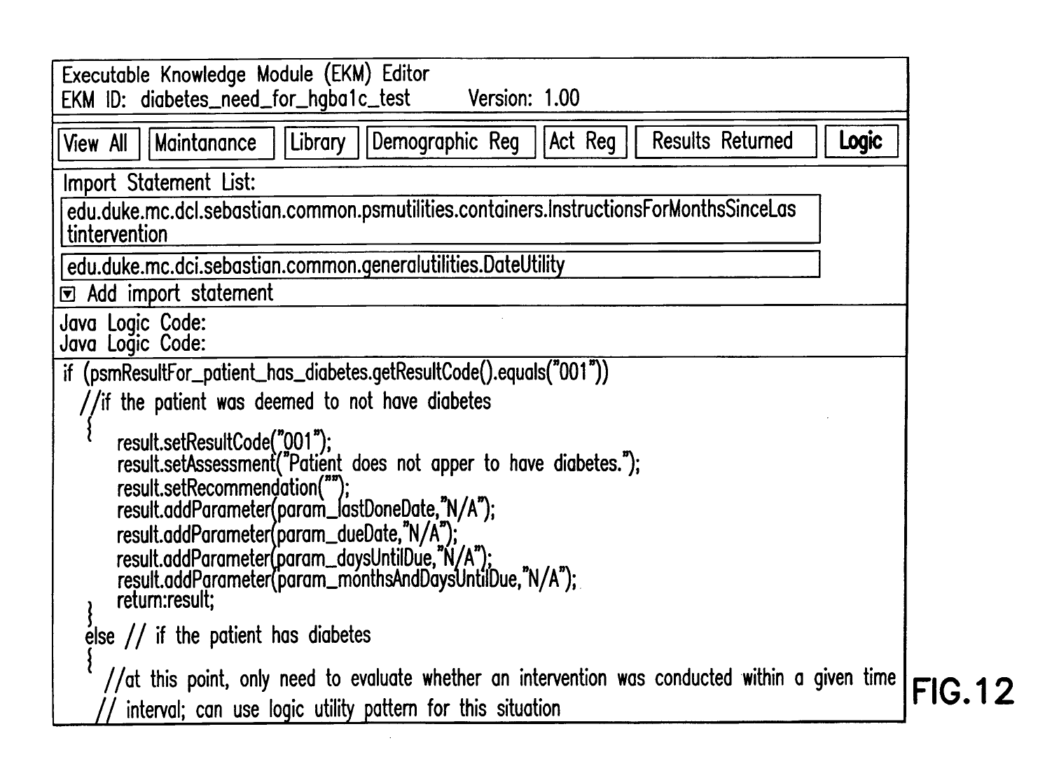

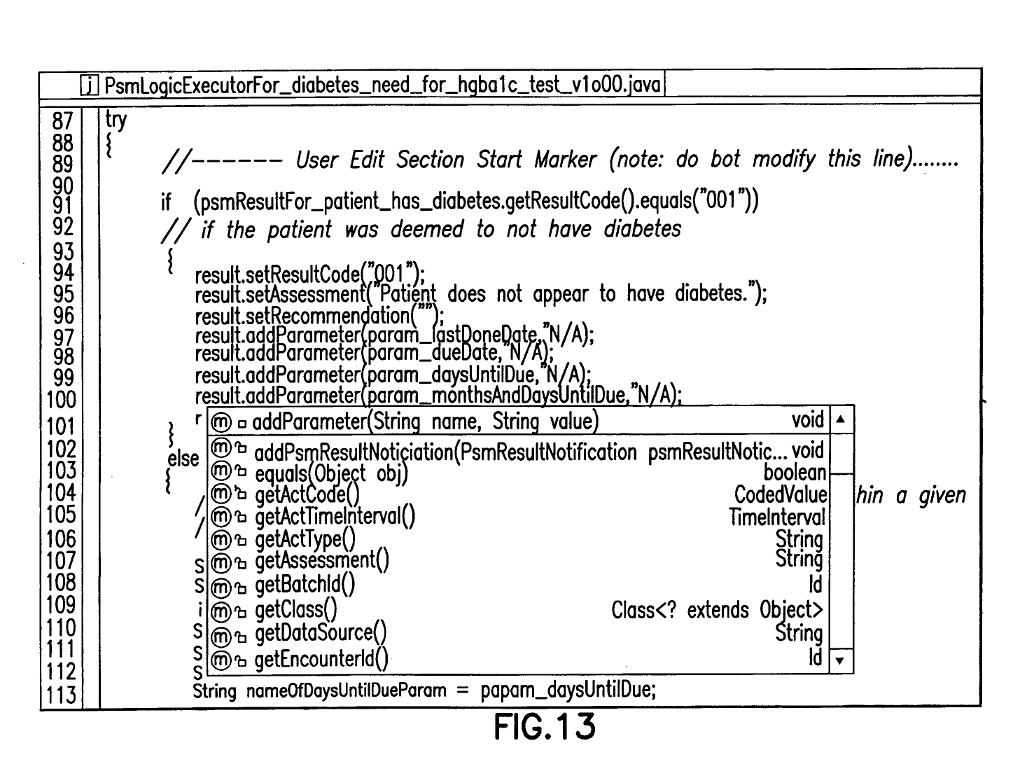

FIG. 12 provides a screen of the decision logic section as viewed through the InfoPath® editor, while FIG. 13 provides a screen of the decision logic as it is being edited in a Java Integrated Development Environment (IDE). It will be appreciated in FIG. 13 that because the decision logic is being edited in a native IDE environment, there is a robust provision of editing support, including such features as error highlighting and code auto-completion.

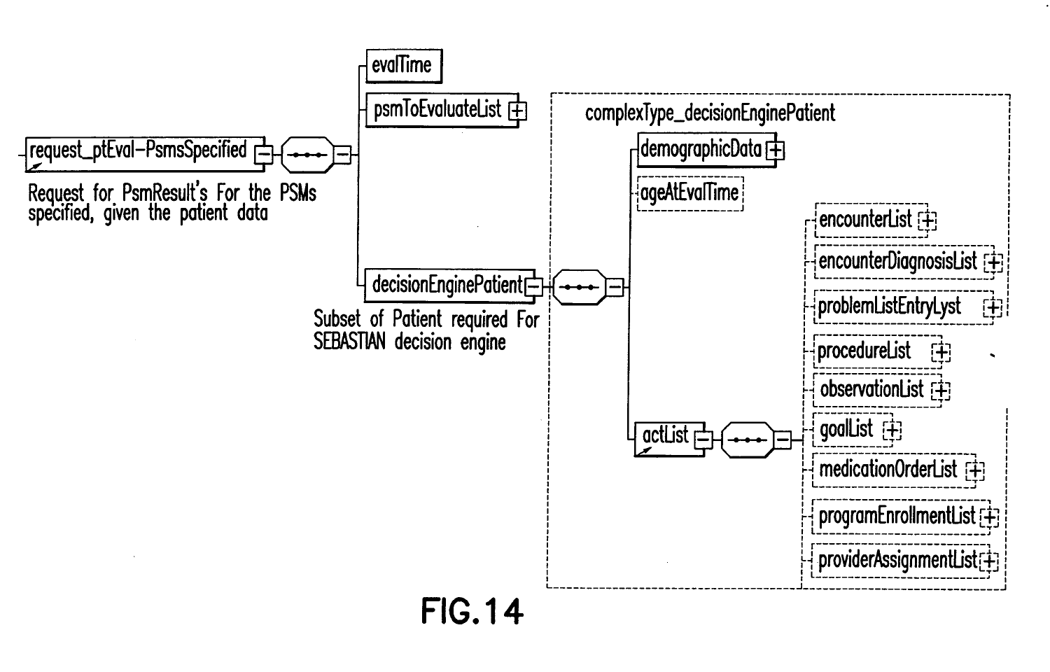

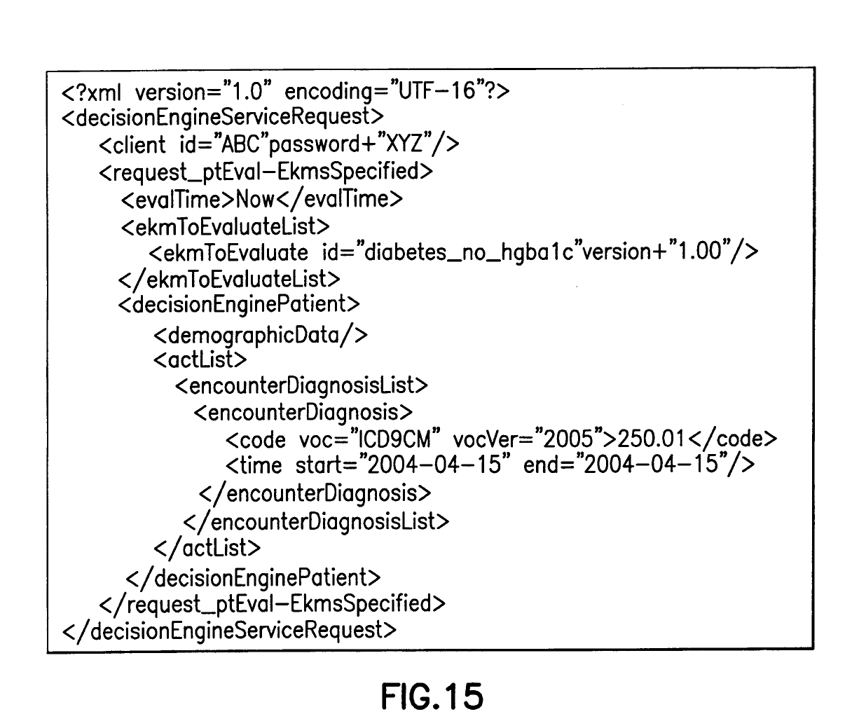

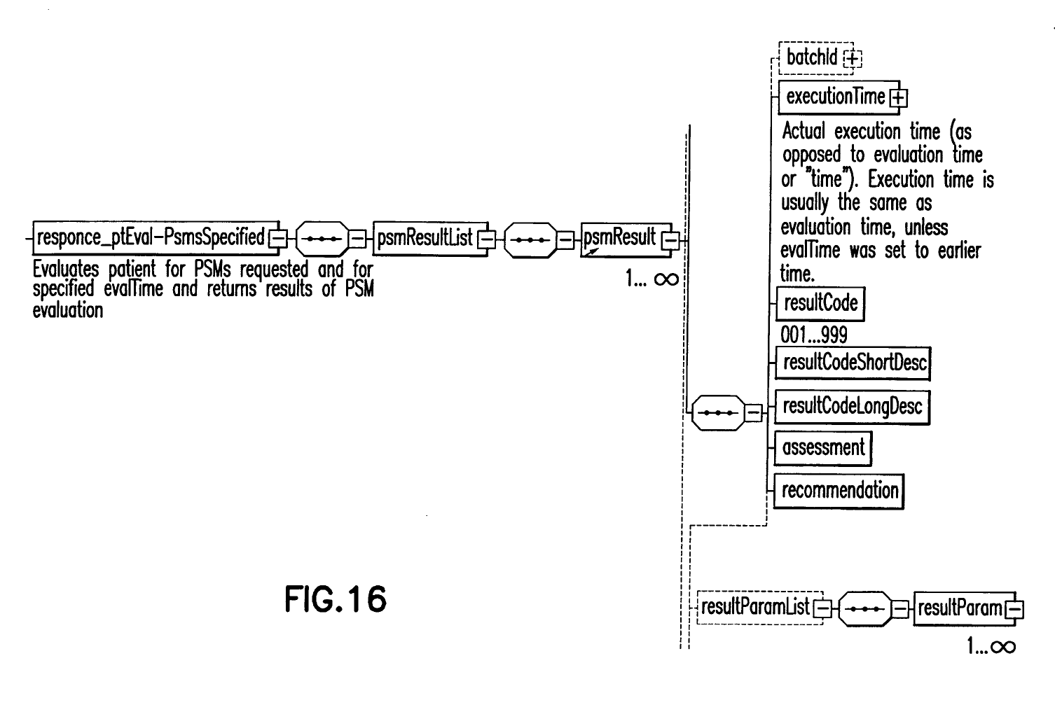

Services Provided—Details. The SEBASTIAN system can be configured to provide, as a primary service, a patient evaluation service, in which client systems obtain machine-interpretable decision support results for specified knowledge modules. In requesting this service, the client can submit the minimum data set required by the knowledge modules, or the client can alternatively submit a superset of the required data (e.g., all available data). To facilitate testing, the SEBASTIAN system framework permits clients to specify a time other than “now” as the time attributed by the system when evaluating a patient. A schematic representation of a patient evaluation request is shown in FIG. 14, and a sample patient evaluation request in XML format is shown in FIG. 15. It will be appreciated that, to the extent possible, data that may be used to identify a patient, e.g., name and medical record number, are not included in this request for a patient evaluation. A schematic representation of the response from SEBASTIAN is shown in FIG. 16. As illustrated earlier in Table 2, the response from SEBASTIAN is comprised primarily of EKM results, whose core components include a result code, a patient-specific assessment message, a patient-specific recommendation message, and optionally a list of machine-interpretable result parameters (e.g., the last date that a test was done, or the number of low-severity emergency room visits that a patient has had over the past 12 months).

In addition, the SEBASTIAN system can be configured to provide the following illustrative auxiliary services: (1) a knowledge module identification service that identifies the knowledge modules that meet client search criteria; (2) a knowledge module description service that provides descriptions of selected modules, including descriptions of the results that will be returned following patient evaluation; and (3) a data requirement specification service that specifies the consolidated data requirements for a set of knowledge modules.

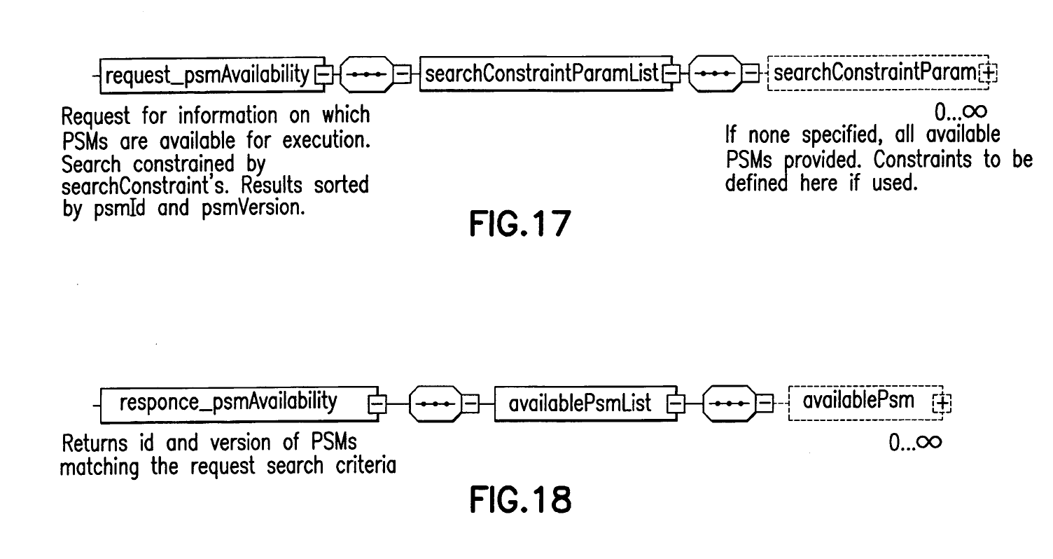

FIG. 17 provides a schematic representation of a client request to the knowledge module identification service, and FIG. 18 provides a schematic representation of the SEBASTIAN response to the request. In an example interaction, a client might request for EKMs related to diabetes management or EKMs endorsed by a specified professional association, to which the service response includes a listing of all EKMs that fulfill the specified search criteria.

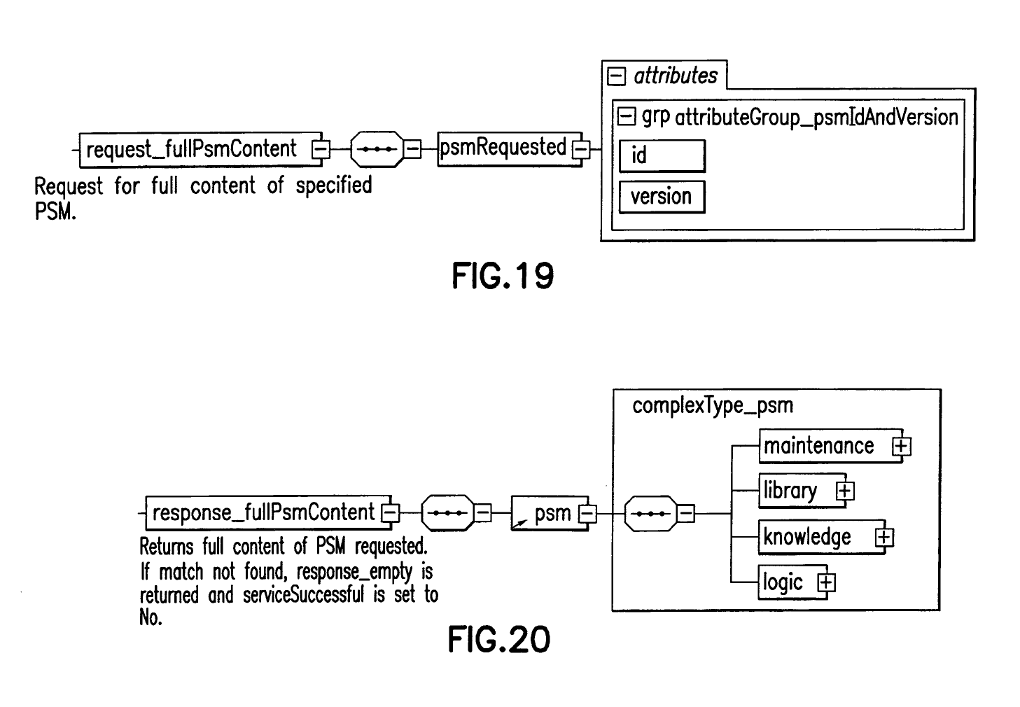

FIG. 19 provides a schematic representation of a client request to the knowledge module description service, and FIG. 20 provides a schematic representation of the SEBASTIAN response to the request. In an example interaction, a request may be made for information on the content of a specified EKM, to which the service responds with information on the requested EKM, such as information on the research evidence on which the EKM is based, the authors of the EKM, or on the format and meaning of results that will be returned by the EKM.

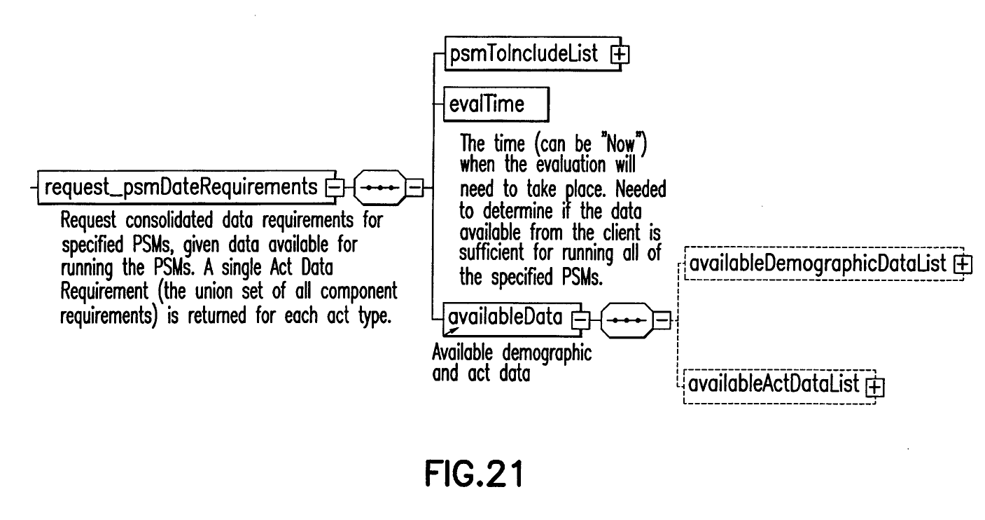

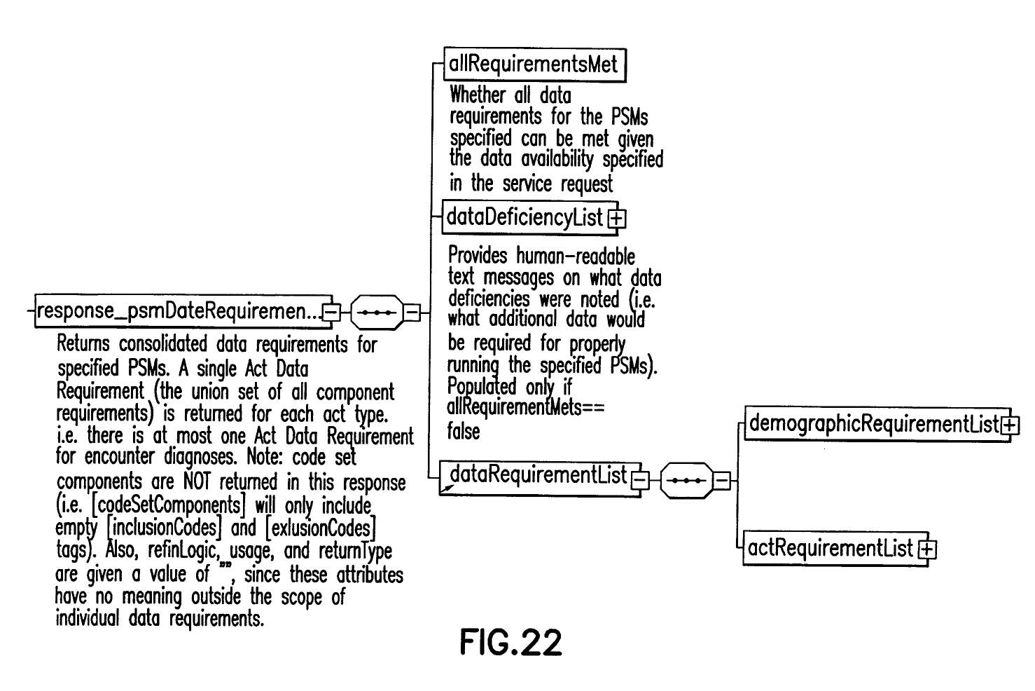

FIG. 21 provides a schematic representation of a client request to the data requirement service, and FIG. 22 provides a schematic representation of the SEBASTIAN response to the request. The data requirement service request includes the list of knowledge modules to consider, the evaluation time, and the list of act and demographic data available to the client. The data requirement service response includes an indication of whether all data requirements for the specified PSMs can be met given the client's data availability, information on any data deficiencies, and information on act and demographic data requirements. The data deficiency list provides clinician-readable text messages of noted data deficiencies, i.e., additional data that would be necessary to for proper running of the specified PSMs. The data deficiency list is populated only if the data requirements criteria are not met. The service response includes consolidated data requirements for the specified PSMs, with a single act data requirement (the union set of all component requirements) being returned for each act type, so that there is maximally only one act data requirement for a given act type (e.g. encounter diagnoses).

Use of SEBASTIAN System by Clients—Details. To use the SEBASTIAN system, the developer of a client system first identifies the set of knowledge modules that will best meet the developer's application needs. Second, the developer verifies that she has access to the data required by the selected modules. Third, the developer ensures that when decision support functionality is needed, the client system will: (a) retrieve the required patient data, (b) send a request to the SEBASTIAN system to evaluate the patient using the relevant modules, (c) parse the EKM results that are returned, and (d) process the decision support results to meet user needs.

The clinical decision support system of the invention is described more fully below in illustrative implementations of the decision support system.

Use of Clinical Decision Support System for Population Health Management. In one implementation, the clinical decision support system of the invention is employed to manage the health of a population of Medicaid beneficiaries. To begin, the developer uses the clinical decision support system's knowledge module identification service to identify the available knowledge modules of interest. The developer then uses the knowledge module description service to determine what decision support results she will be able to use when implementing the population health management system.

Following implementation, the population health management system utilizes the patient evaluation service on a nightly basis to identify issues of concern within this population, such as overdue preventive care needs, poorly controlled diabetes, and frequent use of the emergency department for non-urgent care. These care needs are identified using Medicaid billing data, encounter data obtained from hospital information systems and clinic management systems, and health risk data collected directly from patients using touch-screen kiosks. The data queried from these patient data sources are dynamically determined, based on the data requirements specified by the data requirement specification service. Once obtained, the patient data are consolidated into a single patient representation prior to being passed to the patient evaluation service.

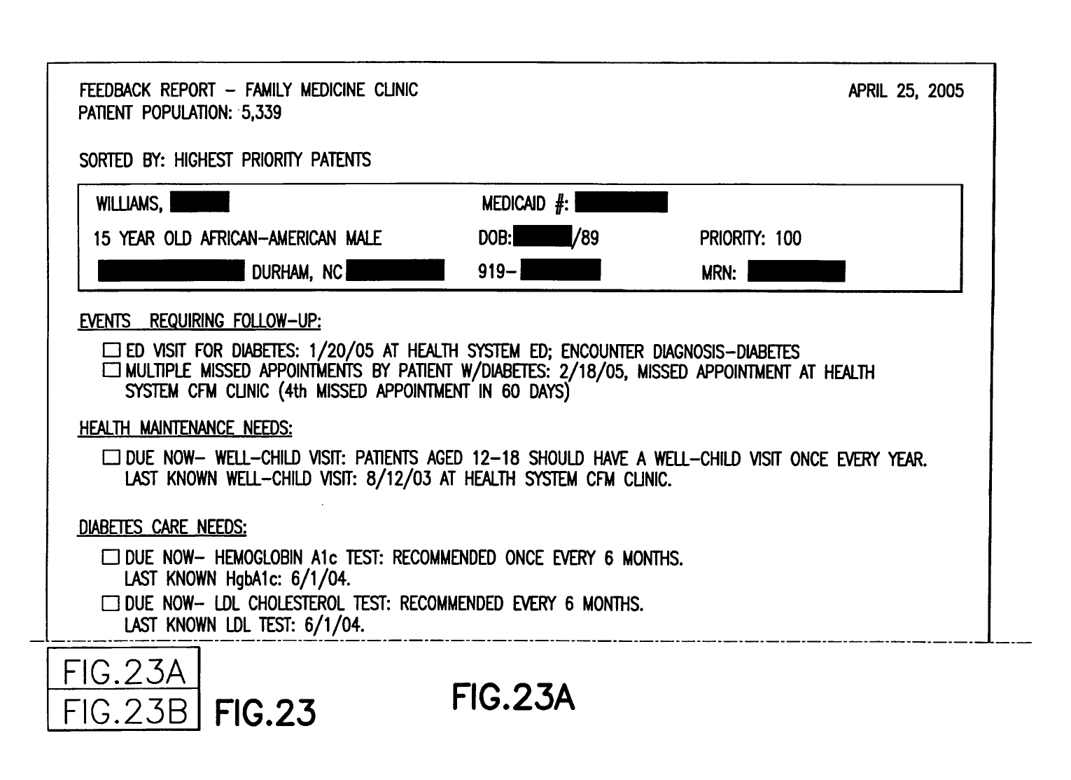

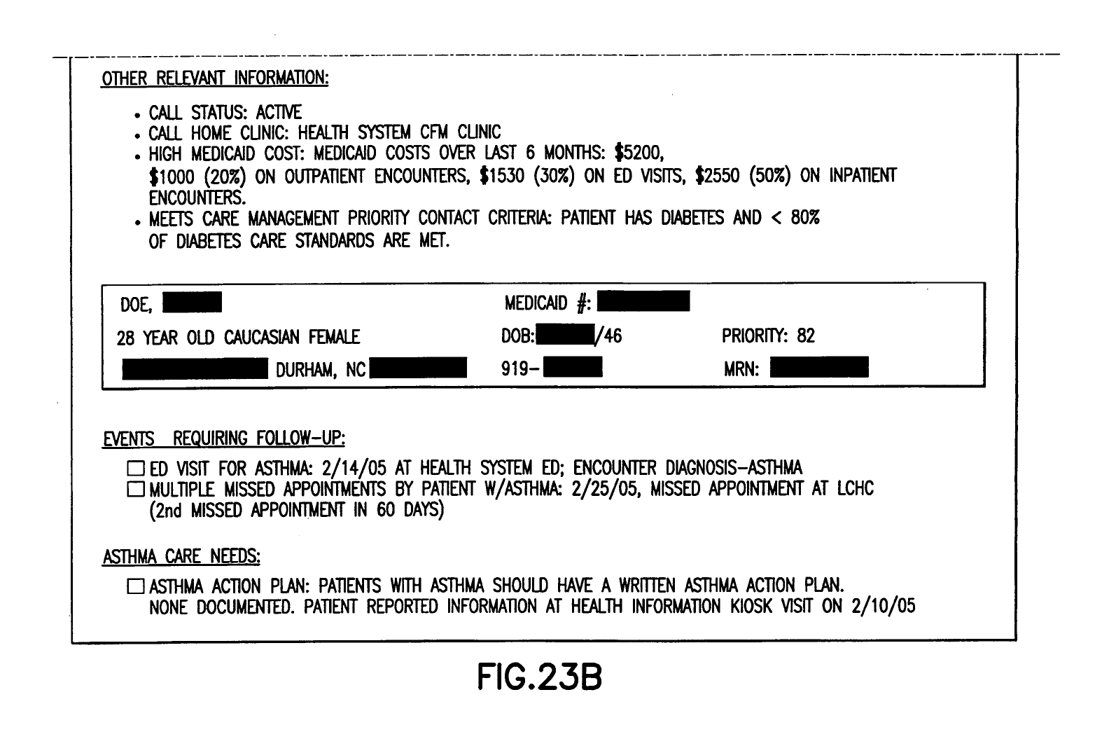

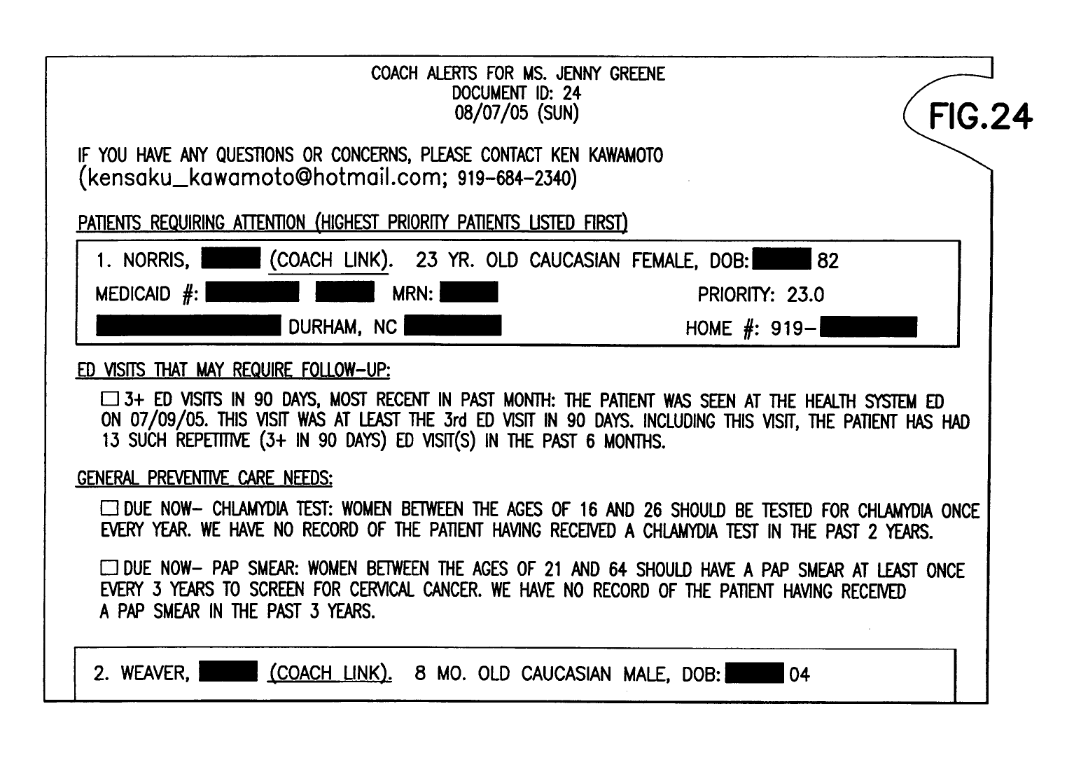

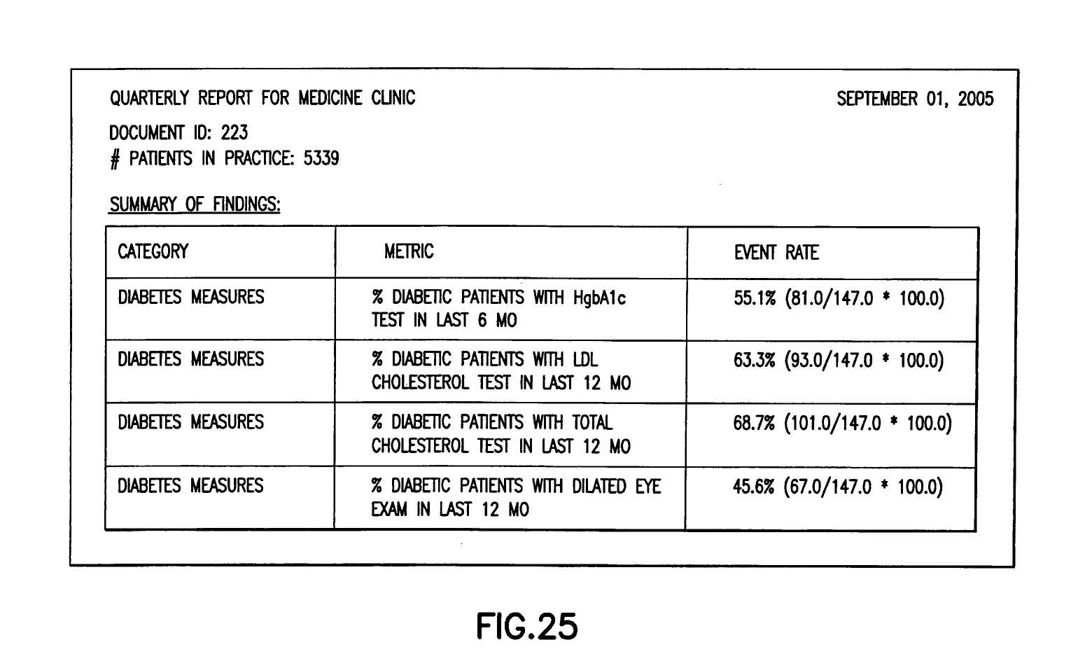

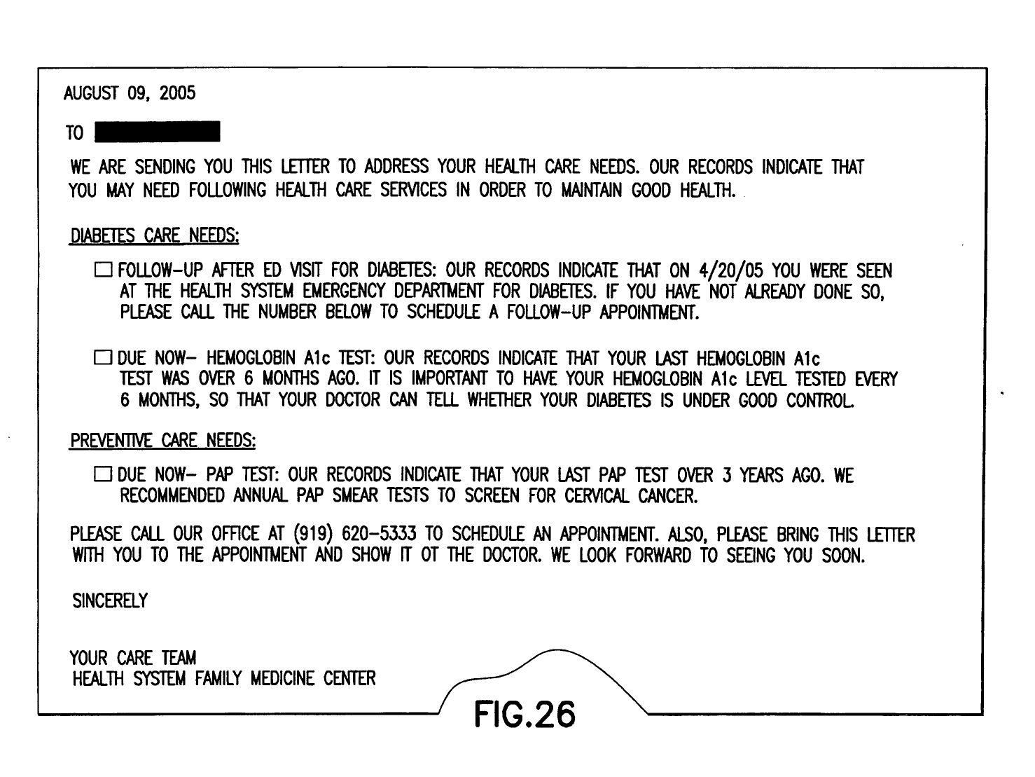

Based on the inferences made by the patient evaluation service, the population health management system in one embodiment provides patients' primary care clinics with reports that list the patients most in need of services, along with identified care needs and recommended actions. The system in another embodiment emails alerts to appropriate health care providers regarding care issues requiring follow-up, the system in a third embodiment generates summary statistics for the patient population, and the system in a fourth embodiment generates care reminder letters for patients in English and, when applicable, in Spanish. A sample clinic feedback report is provided in FIG. 23, a sample provider alert is provided in FIG. 24, a sample statistical summary report is provided in FIG. 25, and a sample patient letter is provided in FIG. 26. It will be appreciated that both the clinic feedback reports and the provider alerts allow health care providers to track patients on a prioritized basis, to facilitate contact, therapeutic intervention, monitoring of progress of care, public health reporting, and the like.

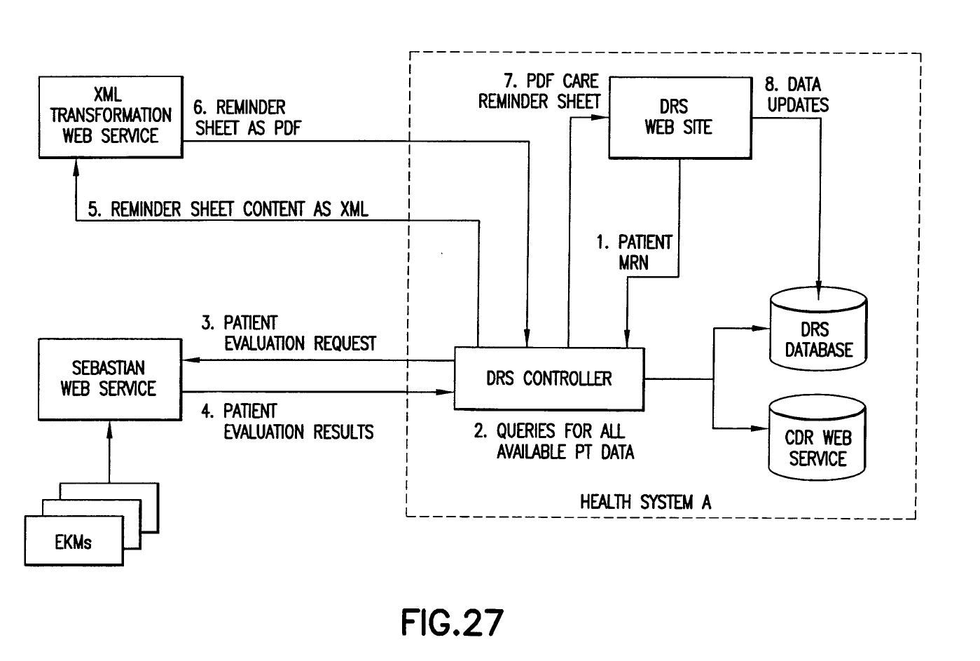

Use of Clinical Decision Support System for Outpatient Diabetes Management. In another embodiment, the clinical decision support system is implemented as an outpatient diabetes reminder system, as depicted in FIG. 27, including multiple executable knowledge modules (EKMs) for diabetes management, a common data repository (CDR) and a patient medical record number (MRN).

In order to implement the diabetes reminder system, the developer first uses the clinical decision support system's knowledge module identification service to identify the available knowledge modules related to diabetes management. The developer then uses the knowledge module description service to determine what decision support results she will be able to use when implementing the diabetes reminder system. Furthermore, the developer uses the data requirement specification service to identify the data that will be required to evaluate patients using the diabetes knowledge modules, and she ensures that the diabetes reminder system has access to the data required for properly evaluating patients using those modules.

Following implementation of the system, when a patient with diabetes checks into a clinic, an intake nurse or other medical professional accesses the diabetes reminder system Web page and requests a diabetes care reminder sheet for the patient (arrow 1). The diabetes reminder system controller application then requests all available information on the patient from the medical center CDR through a Web service interface (arrow 2). The CDR Web service provides data on prior encounter diagnoses using ICD9 codes, procedures using CPT4 codes, past and scheduled encounters using medical center-specific codes, allergies using First DataBank codes, and laboratory results using a vendor-specific coding scheme. The diabetes reminder system controller also retrieves data from a local, diabetes reminder system-specific database that uses SNOMED CT to store data not otherwise collected in a coded format (e.g., whether a microfilament foot exam was done).

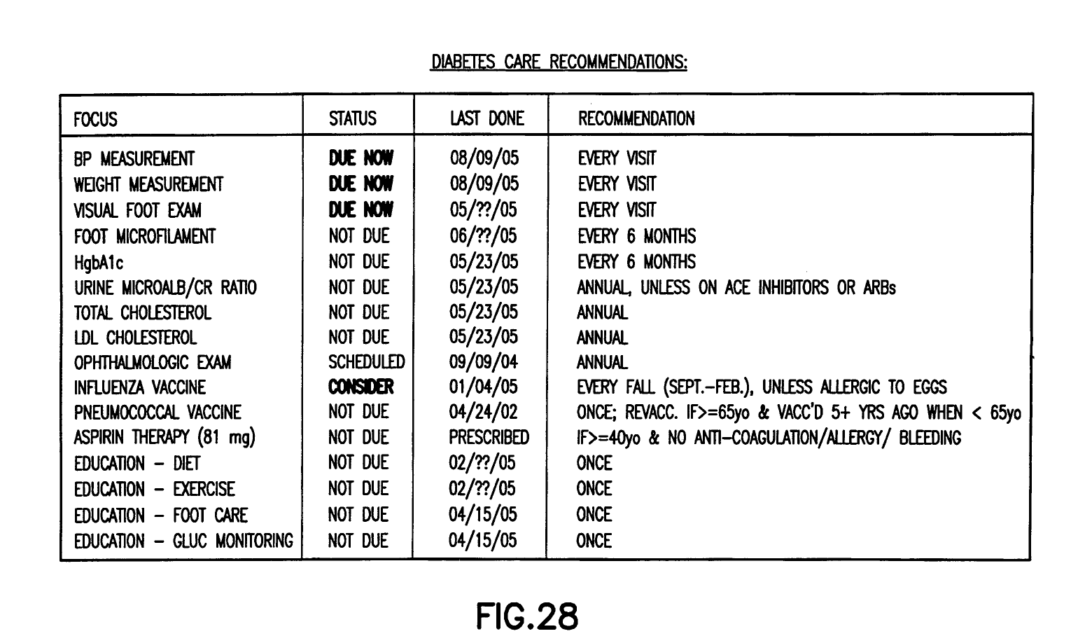

After consolidating the retrieved data into a single patient object, the DRS controller makes a request to the clinical decision support system to evaluate the patient using 13 EKMs for diabetes management (arrow 3). Upon receiving the EKM results (arrow 4), the controller generates an XML document representing the contents of a reminder sheet. This XML document is passed to an XML transformation Web service (arrow 5), which uses an XSL stylesheet to convert the XML content into a PDF document (arrow 6). This PDF reminder sheet is streamed to the Web browser (arrow 7), so that the nurse or other medical professional can print out the sheet and attach it to the patient's chart for clinician review. The reminder sheet consists of a section with relevant previous values, a section where clinicians can enter data not otherwise collected in a coded format, and a section that provides decision support on needed care, as depicted in FIG. 28. Any data updates can be recorded by clinic support staff through the diabetes reminder system Web site (arrow 8).

Salient Features of the Invention. The clinical decision support system of the invention represents a significant advance in the art in at least two ways: (i) the invention provides a service framework wherein clinical clients can embed medical decision logic in their software applications in an efficient and generalizable manner, and (ii) the invention provides a method for knowledge providers to efficiently encode medical knowledge in a format that can be easily adapted to support this service framework. Notable features of each of these aspects of the invention are outlined herein.

With regard to the method by which clients interact with the network server to obtain decision support on patients, salient features of the invention include the following:

(i) The system framework allows the same knowledge modules to be re-used across diverse applications and care settings. For example, all five of the decision support system embodiments described hereinabove use the same EKMs for diabetes care, despite significant differences in functionality and data sources.

(ii) The only client infrastructure requirement is a network, e.g., an Internet connection.

(iii) The framework is designed to be as complex as necessary, but as simple as possible. Thus, the effort required to train client developers on use of the framework is reduced.

(iv) The client can make use of medical knowledge encoded using diverse knowledge representation formalisms, as long as the knowledge provider implements the service interface as described. Also, the client does not need to understand how the knowledge modules have been implemented, which can be a significant advantage given that many knowledge representation formalisms are quite complex and can be difficult for even a practitioner in the field to understand.

(v) The framework provides a high degree of security to clients, as the network server is not required to have direct read/write access to the client's database(s) containing patient information. Also, to the extent possible, information that can be used to identify a patient (e.g., name, medical record number) is not passed between the client and the server.

(vi) Contrary to many decision support architectures, the framework does not make assumptions about how clients make use of decision support results. Thus, clients are not constrained as to the type of application that can be developed using the framework. For example, the framework has already been utilized to implement an outpatient disease management system, a provider alert system, a clinic feedback report system, a patient letter system, and a statistical reporting system. The system is readily adaptable for use in other types of medical software applications, including computerized physician order entry applications, insurance prior authorization applications, and critical value alerting systems.

(vii) The framework can be adapted to use a standard patient information model and standard medical vocabularies. For example, the framework can be adapted to use the HL7 RIM as the information model and UMLS vocabularies as the standard vocabularies.

(viii) The framework can be adapted to allow the specification of a given data requirement using multiple vocabularies. Thus, the framework can fully support clients using different vocabularies to encode their data, without having to rely on a process such as runtime vocabulary translation that may introduce unexpected errors.

(ix) The framework allows the client to construct a consolidated patient representation using data obtained from multiple patient data sources, and to have that consolidated representation of the patient assessed through the patient evaluation service.

(x) The framework associates data requirements with individual knowledge modules and with sets of knowledge modules, rather than with the patient evaluation service in its entirety. As a consequence, a client is not required to have access to all possible types of data that can be used in knowledge modules; rather, a client is simply required to have access to the data types actually used in the knowledge modules that the client desires to execute. Thus, both clients with limited availability of coded patient data and clients with rich data availability are supported by the framework. Furthermore, knowledge providers can introduce data requirements for one knowledge module without increasing the data requirements for the patient evaluation service as a whole.

(xi) The framework facilitates knowledge maintenance by encapsulating executable medical knowledge into modules that are independent of application code, version controlled, tagged with meta-data, and maintained centrally on behalf of multiple client applications.

(xii) Comprehensive testing is supported by a clear input/output interface and the ability to evaluate a patient at any point in time, past or future. For example, static test cases will remain valid over time, as long as repeated requests to evaluate test cases all specify the same point in time.

(xiii) The framework can be adapted so that knowledge modules may return various types of machine-interpretable result parameters following patient evaluation. This significantly increases the client's flexibility in generating decision support results. For example, the result parameters returned by a preventive care knowledge module (e.g., status of preventive care intervention, date last done, location last done, date due) can be used to generate appropriate message texts for the specific target audience, such as Spanish-speaking patients, English-speaking low literacy patients, French-speaking guardians of pediatric patients, and English-speaking physicians.

(xiv) The framework can be implemented in a fashion that is performance-optimized. For example, in one embodiment of the clinical decision support system, implemented as a diabetes reminder system, a request to process the 13 EKMs used by the diabetes reminder system takes ˜350 ms to complete, even when a superset of the required patient data is provided (e.g., data on 274 acts).

(xv) The clinical decision support system of the invention can be usefully employed to implement software applications having significant clinical utility.

(xvi) The clinical decision support system of the invention also addresses a growing need and interest among academic, commercial, and government stakeholders to establish a common services framework for clinical decision support, by specification of a common architecture for authoring and delivering executable medical knowledge.

Furthermore, with regard to the method by which the invention allows knowledge providers to implement the aforementioned service framework using executable knowledge modules, salient features include the following:

(i) The knowledge encoded in an executable knowledge module can be readily adapted to provide the decision support services of the aforementioned service framework. For example, the information in the library section can be used to implement the knowledge identification service, the information in the data requirement subsection of the knowledge section can be used to implement the data requirement specification service, and the information in the logic section can be used to implement the patient evaluation service.

(ii) The use of a standard data storage standard such as XML allows the executable knowledge modules to be edited using powerful standards-based tools. For example, XML Schemas can be used to validate the syntactic correctness of EKMs, and a functionally rich InfoPath® form can be used for module authoring.

(iii) The ability to “nest” EKMs significantly increases the efficiency of creating and maintaining knowledge modules.

(iv) Multiple, significant benefits are attained by the invention's ability to convert EKM data requirements into native programming language objects that can be manipulated in a native programming environment to construct EKM result objects. These advantages include: (a) the ability to create utility functions to handle common logic patterns; (b) the ability to use powerful Integrated Development Environments (IDEs) for authoring and editing decision logic rules; (c) the ability to easily access external knowledge sources, such as knowledge stored in relational databases or XML documents; and (d) the ability to invoke other decision support engines from within the logic section, thereby enabling the framework to serve as a common platform for delivering executable medical knowledge that has been represented using different formalisms.

In summary, the utility of the clinical decision support system of the invention includes the capability of authoring, processing and delivering machine-executable decision logic to diverse medical software applications more easily and more efficiently than is currently possible. By facilitating the efficient development and maintenance of knowledge-based medical software applications, the system of the present invention facilitates a more widespread adoption of clinical decision support systems, which have been demonstrated to be highly effective in improving care quality and ensuring patient safety.

Also, it will be appreciated that the invention could be applied outside of health care. For example, the invention could be applied to the field of banking, in which the entity evaluated is a mortgage applicant instead of a patient, and the data required to evaluate the entity is financial records rather than health records. Furthermore, it will be appreciated that the invention could be used to fulfill the requirements of the HL7 Decision Support Service specification (see Health Level 7. HL7 Decision Support Service [DSS] Service Functional Model, available at: http://www.hl7.org/v3ballot/html/infrastructure/dss/dss.htm, accessed Jul. 28, 2006).

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A clinical decision support system, comprising a network server adapted for communication with a network by which the network server and a client can communicate with one another, wherein said client includes one or more client applications and one or more patient data sources,
said network server being programmably coupled with one or more knowledge modules capable of using patient data to make inferences regarding a patient,
wherein said network server is capable of communicating to said client what knowledge modules are available for evaluating patients,
wherein said network server is capable of communicating to said client the data requirements for evaluating a patient using one or more said knowledge modules,
wherein said network server is capable of communicating to said client what conclusions can be drawn regarding a patient using one or more said knowledge modules,
wherein said network server is programmably arranged for said communication with said client to (i) receive from said client application requests to evaluate one or more patients using one or more said knowledge modules, wherein the data provided by the client application includes patient data obtained from said patient data source(s), and to (ii) responsively transmit to said client application patient-specific inferences, and
wherein communications between said network server and said client application utilize a network communications language that is interoperative with different operating systems and programming languages.

2. The system of claim 1, adapted to provide at least one service selected from the group comprising:
(i) a service in which said network server receives from said client requests to describe the knowledge modules that can be used to draw inferences regarding a patient, with the request optionally constrained by one or more search parameters, wherein said network server responsively transmits to said client information on knowledge modules meeting search criteria;
(ii) a service in which said network server receives from said client requests to describe the data requirements for drawing inferences regarding a patient using specified knowledge modules, wherein said network server responsively transmits to said client information on the data required to properly evaluate a patient using the specified modules; and
(iii) a service in which said network server receives from said client requests to describe one or more specified knowledge modules, wherein said network server responsively transmits to said client information on said knowledge modules, including information on the format and meaning of the machine-interpretable inferences that can be drawn when patients are evaluated using the modules.

3. The system of claim 2, wherein said network server is programmably coupled with a plurality of executable knowledge modules specifying data requirements for assessing a patient, patient-specific conclusions that can be drawn from using that data, and instructional logic utilized to generate the patient-specific conclusions using the specified patient data.

4. The system of claim 1, wherein said network comprises at least one of an intranet, extranet and internet.

5. The system of claim 3, wherein said network comprises at least one of an intranet, extranet and internet.

6. The system of claim 4, wherein said network includes an internet.

7. The system of claim 5, wherein said network includes an internet.

8. The system of claim 1, wherein the network is bypassed in a special case in which the network server and client application are located on the same computer.

9. The system of claim 3, wherein the network is bypassed in a special case in which the network server and client application are located on the same computer.

10. The system of claim 1, wherein the network supports information protocols including at least one of HTTP and XML.

11. The system of claim 3, wherein the network supports information protocols including at least one of HTTP and XML.

12. The system of claim 10, wherein said information protocols include HTTP.

13. The system of claim 11, wherein said information protocols include HTTP.

14. The system of claim 10, wherein said information protocols include XML.

15. The system of claim 11, wherein said information protocols include XML.

16. The system of claim 1, wherein said communications utilize Health Level 7 (HL7) messages.

17. The system of claim 3, wherein said communications utilize HL7 messages.

18. The system of claim 1, wherein the system utilizes a standards-based patient information model.

19. The system of claim 3, wherein the system utilizes a standards-based patient information model.

20. The system of claim 18, wherein said patient information model includes at least part of the HL7 Reference Information Model (RIM).

21. The system of claim 21, wherein said patient information model includes at least part of the HL7 RIM.

22. The system of claim 1, wherein data requirements can be specified using multiple vocabularies.

23. The system of claim 3, wherein data requirements can be specified using multiple vocabularies.

24. The system of claim 22, where said vocabularies include one or more vocabularies included in the National Library of Medicine's Unified Medical Language System.

25. The system of claim 23, where said vocabularies include one or more vocabularies included in the National Library of Medicine's Unified Medical Language System.

26. The system of claim 1, wherein data requirements are associated with individual knowledge modules, rather than with said patient evaluation service as a whole.

27. The system of claim 3, wherein data requirements are associated with individual knowledge modules, rather than with said patient evaluation service as a whole.

28. The system of claim 1, wherein said client can request a patient to be evaluated at any point in time, past or future.

29. The system of claim 3, wherein said client can request a patient to be evaluated at any point in time, past or future.

30. The system of claim 1, wherein said patient evaluation service returns machine-interpretable results that comprise at least one of the following: a unique result code, a patient-specific assessment message, a patient-specific recommendation message, and zero or more result parameters.

31. The system of claim 3, wherein said patient evaluation service returns machine-interpretable results that comprise at least one of the following: a unique result code, a patient-specific assessment message, a patient-specific recommendation message, and zero or more result parameters.

32. The system of claim 3, wherein the network server is arranged to communicate with the client by messaging communication and is programmably arranged to generate said patient-specific inferences based on information from at least one of said plurality of executable knowledge modules.

33. The system of claim 32, wherein the messaging communication comprises XML messaging communication.

34. The system of claim 32, wherein the network server is programmably arranged as a servlet hosted by a servlet container.

35. The system of claim 32, wherein the network server is programmably arranged to include a standards-based patient information model.

36. The system of claim 3, wherein patients are modeled in the patient information model as entities described by data elements including act data and demographic data.

37. The system of claim 36, wherein the act data include health care service data selected from the group comprising encounters, encounter diagnoses, problem list entries, procedures, observations, goals, medication orders, program enrollments, provider assignments, invoices, and past executable knowledge module results.

38. The system of claim 36, wherein the act data include health care service data selected from the group comprising health care service encounter data, diagnostic data and intervention data.

39. The system of claim 36, wherein the demographic data include at least one of patient gender, race(s), age and birth date.

40. The system of claim 34, wherein the servlet is programmably arranged to include a standards-based patient information model.

41. The system of claim 35, wherein the standards-based patient information model includes at least part of the HL7 Reference Information Model (RIM).

42. The system of claim 3, wherein each of the executable knowledge modules includes a maintenance section, a library section, a knowledge section and a logic section.

43. The system of claim 3, wherein the executable knowledge modules use vocabularies included in the National Library of Medicine's Unified Medical Language System (UMLS).

44. The system of claim 1, adapted to provide a patient evaluation service.

45. The system of claim 3, adapted to provide a patient evaluation service.

46. The system of claim 42, wherein the maintenance section includes at least one of title, identifier, version number, and authors.

47. The system of claim 42, wherein the library section includes bibliographic information.

48. The system of claim 47, wherein the bibliographic information includes at least one of module purpose, explanation of module logic, keywords, references, and endorsing entities.

49. The system of claim 3, wherein said plurality of executable knowledge modules includes at least one executable knowledge module that is nestable within another executable knowledge module in said plurality of modules.

50. The system of claim 49, wherein said at least one nestable module is evaluated first and its results are made available to said another executable knowledge module.

51. The system of claim 3, adapted to generate a corresponding class or method in a programming language for each executable knowledge module, within which data elements corresponding to module data requirements can be accessed as programming objects.

52. The system of claim 51, wherein said programming objects are used to construct the patient-specific inferences returned by the patient evaluation service.

53. The system of claim 52, wherein said programming language is an object-oriented programming language.

54. The system of claim 53, wherein said object-oriented programming language is Java.

55. The system of claim 1, wherein the client constructs a consolidated patient representation using data from multiple patient data sources, and has said consolidated patient representation evaluated by the patient evaluation service.

56. The system of claim 3, wherein the client constructs a consolidated patient representation using data from multiple patient data sources, and has said consolidated patient representation evaluated by the patient evaluation service.

57. The system of claim 1, wherein said patient evaluation request is accompanied by a minimum data set required by the network server for evaluating the patient.

58. The system of claim 3, wherein said patient evaluation request is accompanied by a minimum data set required by the network server for evaluating the patient.

59. The system of claim 1, wherein said patient evaluation request is accompanied by a superset of the data required by the network server for evaluating the patient.

60. The system of claim 3, wherein said patient evaluation request is accompanied by a superset of the data required by the network server for evaluating the patient.

61. The system of claim 1, wherein said patient evaluation request is accompanied by additional relevant data, including at least one of context data and client preference data.

62. The system of claim 3, wherein said patient evaluation request is accompanied by additional relevant data, including at least one of context data and client preference data.

63. The system of claim 1, wherein said data requirements for knowledge modules can include at least one of context data and client preference data.

64. The system of claim 3, wherein said data requirements for knowledge modules can include at least one of context data and client preference data.

65. The system of claim 1, adapted for population health management of a patient population.

66. The system of claim 3, adapted for population health management of a patient population.

67. The system of claim 65, adapted for population health management of patients who are Medicaid beneficiaries.

68. The system of claim 66, adapted for population health management of patients who are Medicaid beneficiaries.

69. The system of claim 65, adapted to identify issues of concern with said population.

70. The system of claim 66, adapted to identify issues of concern with said population.

71. The system of claim 69, wherein said issues of concern include at least one issue selected from the group comprising overdue preventive care needs, suboptimal chronic disease management, and inappropriate utilization of health care resources.

72. The system of claim 70, wherein said issues of concern include at least one issue selected from the group comprising overdue preventive care needs, suboptimal chronic disease management, and inappropriate utilization of health care resources.

73. The system of claim 1, adapted to provide patients' primary care clinics with reports that list the patients most in need of services, along with identified care needs and recommended actions.

74. The system of claim 3, adapted to provide patients' primary care clinics with reports that list the patients most in need of services, along with identified care needs and recommended actions.

75. The system of claim 1, adapted to provide alerts to health care providers regarding care issues requiring follow-up.

76. The system of claim 3, adapted to provide alerts to health care providers regarding care issues requiring follow-up.

77. The system of claim 1, adapted to generate care reminder letters for patients.

78. The system of claim 3, adapted to generate care reminder letters for patients.

79. The system of claim 1, adapted to provide disease management recommendations in an outpatient setting.

80. The system of claim 3, adapted to provide disease management recommendations in an outpatient setting.

81. A clinical decision network system, comprising a clinical decision support system as claimed in claim 1, a client including one or more client applications and one or more patient data sources, and a network interconnecting the network server and client for communication with one another.

82. A clinical decision network system, comprising a clinical decision support system as claimed in claim 3, a client including one or more client applications and one or more patient data sources, and a network interconnecting the network server and client for communication with one another.

83. The clinical decision network system of claim 81, wherein the client application is comprised in a medical information system of a medical care facility.

84. The clinical decision network system of claim 82, wherein the client application is comprised in a medical information system of a medical care facility.

85. A method of providing clinical decision support in a medical care facility, comprising use of a clinical decision support system as claimed in claim 1 for network support of a clinical client associated with said medical care facility.

86. A method of providing clinical decision support in a medical care facility, comprising use of a clinical decision support system as claimed in claim 3 for network support of a clinical client associated with said medical care facility.

87. The method of claim 85, wherein said clinical client is comprised in a medical information system of said medical care facility.

88. The method of claim 86, wherein said clinical client is comprised in a medical information system of said medical care facility.

89. A method of health care services delivery, comprising providing a Web service for clinical decision support, in which said Web service comprises use of a clinical decision support system as claimed in claim 1.

90. A method of health care services delivery, comprising providing a Web service for clinical decision support, in which said Web service comprises use of a clinical decision support system as claimed in claim 3.

91. The method of claim 89, wherein said clinical decision support system is adapted to provide at least one service selected from the group comprising: (1) services that identify knowledge modules that meet client search criteria; (2) services that provide descriptions of selected knowledge modules, including descriptions of results that will be returned following patient evaluation; and (3) services that specify data requirements for a set of knowledge modules.

92. The method of claim 90, wherein said clinical decision support system is adapted to provide at least one service selected from the group comprising: (1) services that identify knowledge modules that meet client search criteria; (2) services that provide descriptions of selected knowledge modules, including descriptions of results that will be returned following patient evaluation; and (3) services that specify data requirements for a set of knowledge modules.

93. The method of claim 89, carried out for population health management for a patient population.

94. The method of claim 90, carried out for population health management for a patient population.

95. The method of claim 93, further comprising providing patients' primary care clinics with reports generated by use of the clinical decision support system, that list the patients most in need of services, along with identified care needs and recommended actions.

96. The method of claim 94, further comprising providing patients' primary care clinics with reports generated by use of the clinical decision support system, that list the patients most in need of services, along with identified care needs and recommended actions.

97. The method of claim 93, further comprising distribution of alerts generated by use of the clinical decision support system to health care providers regarding care issues requiring follow-up.

98. The method of claim 94, further comprising distribution of alerts generated by use of the clinical decision support system to health care providers regarding care issues requiring follow-up.

99. The method of claim 93, further comprising generating care reminder letters for patients in English and, when applicable, in Spanish, by use of the clinical decision support system.

100. The method of claim 94, further comprising generating care reminder letters for patients in English and, when applicable, in Spanish, by use of the clinical decision support system.

101. A method for implementing clinical decision support systems, comprising providing a framework for a clinical decision-support Web service, wherein said framework includes a plurality of executable knowledge modules (EKMs) that define the data requirements for assessing a patient, the conclusions that can be drawn using that data, and instructions on how to generate those conclusions.

102. The method of claim 101, further comprising transmitting decision support communications via a network to a clinical client coupled in communication with the network, in response to decision support requests from the clinical client.

103. The method of claim 102, wherein said decision-support communications are transmitted by said framework to the clinical client by standards-based communication messaging.

104. The method of claim 102, wherein said framework further comprises a servlet for generating said patient-specific conclusions based on information from at least one of said plurality of executable knowledge modules.

105. The method of claim 104, wherein each of the executable knowledge modules includes a maintenance section, a library section, a knowledge section and a logic section.

106. The method of claim 104, adapted to provide at least one Web service selected from the group comprising: (1) services that identify executable knowledge modules that meet client search criteria; (2) services that provide descriptions of selected executable knowledge modules, including descriptions of results that will be returned following patient evaluation; and (3) services that specify data requirements for a set of executable knowledge modules.

107. A framework for implementing clinical decision support systems, comprising a plurality of executable knowledge modules (EKMs) that define the data requirements for assessing a patient, the conclusions that can be drawn using that data, and instructions on how to generate those conclusions, said framework being adapted for implementation of a Web service providing clinical decision support to a client in communication with said framework.

108. The system of claim 2, wherein said network server is programmably coupled with at least one executable knowledge module comprising (i) a specification of the data required for assessing a patient using the module, (ii) a description of the patient-specific conclusions that can be drawn from using that data, and (iii) instructional logic utilized to generate the patient-specific conclusions using the specified patient data.

109. The system of claim 1, wherein said communications utilize HL7 information content.

110. The system of claim 3, wherein said communications utilize HL7 information content.

111. The system of claim 1, wherein said communications utilize information content derived from a standard information model.

112. The system of claim 3, wherein said communications utilize information content derived from a standard information model.

113. The system of claim 111, wherein said information model includes at least part of the HL7 Reference Information Model (RIM).

114. The system of claim 112, wherein said information model includes at least part of the HL7 RIM.

115. The system of claim 32, wherein the network server is programmably arranged to communicate utilizing information content derived from a standard information model.

116. The system of claim 115, wherein the standard information model includes at least part of the HL7 RIM.

117. The system of claim 3, wherein each of the executable knowledge modules is associated with one or more traits that can be used to characterize the knowledge module or to identify knowledge modules of interest.

118. The system of claim 117, wherein knowledge module traits include at least one of identifier, version number, authors, module purpose, explanation of module logic, and keywords.

119. The system of claim 1, wherein the client obtains required data from multiple data sources, and has said required data evaluated by the patient evaluation service.

120. The system of claim 3, wherein the client obtains required data from multiple data sources, and has said required data evaluated by the patient evaluation service.

121. The method of claim 91, wherein said services that specify data requirements for a set of knowledge modules combine similar data requirements into consolidated data requirements.

122. The method of claim 92, wherein said services that specify data requirements for a set of knowledge modules combine similar data requirements into consolidated data requirements.

123. The method of claim 106, wherein said services that specify data requirements for a set of knowledge modules combine similar data requirements into consolidated data requirements.

124. The system of claim 1, wherein the system is adapted to fulfill the requirements of the HL7 Decision Support Service specification.

125. The system of claim 3, wherein the system is adapted to fulfill the requirements of the HL7 Decision Support Service specification.

126. The system of claim 1, wherein the system is adapted to evaluate a group of patients rather than a single patient.

127. The system of claim 3, wherein the system is adapted to evaluate a group of patients rather than a single patient.
